(19) United States
(12) Patent Application Publication
(10) Pub. No.: US 2025/0325986 A1
(43) Pub. Date: Oct. 23, 2025

(54) METHODS AND DEVICES FOR REMOVING PARTICLES FROM FLUIDS

(71) Applicant: Solventum Intellectual Properties Company, Maplewood, MN (US)

(72) Inventors: Kurt J. HALVERSON, Saint Paul, MN (US); Steven P. SWANSON, Saint Paul, MN (US); Alexi J. YOUNG, Saint Paul, MN (US); Alexandra L. CRAMPTON, Saint Paul, MN (US); Emily S. SAVELA, Saint Paul, MN (US); Brian J. GATES, Saint Paul, MN (US); Semra COLAK ATAN, Saint Paul, MN (US); Jerald K. RASMUSSEN, Saint Paul, MN (US); Evan D. BRUTINEL, Saint Paul, MN (US); Katie F. WLASCHIN, Saint Paul, MN (US)

(73) Assignee: Solventum Intellectual Properties Company, Maplewood, MN (US)

(21) Appl. No.: 18/874,960

(22) PCT Filed: Jun. 21, 2023
(86) PCT No.: PCT/IB2023/056427

§ 371 Date: Dec. 13, 2024

Related U.S. Application Data
(60) Provisional application No. 63/354,848, filed on Jun. 23, 2022.
(60) Provisional application No. 63/425,468, filed on Nov. 15, 2022.
(60) Provisional application No. 63/506,603, filed on Jun. 7, 2023.

(51) Int. Cl. B01L 3/00; B01D 21/01; B01D 29/44

(52) U.S. Cl. CPC B01L 3/502761; B01D 21/01; B01D 29/44; B01L 2200/0647; B01L 2300/041; B01L 2400/0406; B01L 2400/0457; B01L 2400/0487

(57) ABSTRACT

The present disclosure provides methods and devices for removing particles from fluids. A method for removing red blood cells includes obtaining a device having a microstructured substrate including microstructures extending across a first surface, where at least a portion of an exterior surface of the microstructures are configured to allow capillary action. The device also includes a cover disposed a selected distance apart from a top of the first surface of the microstructured substrate and at least one sidewall that attaches the cover to the first surface of the microstructured substrate along a perimeter of the first surface of the microstructured substrate. The method further includes filling the device with a volume of blood through the first aperture via capillary action, waiting for a time sufficient for at least a portion of the red blood cells to settle within the first open volume of the microstructures, and applying pressure to the device, thereby causing some of the initial volume of blood, from which at least some of the red blood cells have been retained within the first open volume of the microstructures, to flow out of the device.

### BACKGROUND

Identification and quantification of biomarkers in blood frequently requires removal of red blood cells prior to analysis. Red cells are present in whole blood at concentrations of 35-50%, reported as the hematocrit level. This high concentration can interfere with biomarker assays. The level of interference varies across the physiological hematocrit range leading to variability in the reported concentration of the biomarker. Interference in optical detection assays (for example ELISA) can be caused by light scattering effects and absorbance of hemoglobin in the visible spectrum. Red blood cells can also interfere with electrochemical detection assay methods, for example those commonly utilized in glucose test strips. Chemical species, for example oxygen present in red blood cells, can interfere with oxidation-reduction reactions.

In centralized hospital or clinical laboratories, the separation of red blood cells is achieved via centrifugation. The separation process requires large (e.g., milliliter) volumes of blood collected intravenously in test tubes. During centrifugation red blood cells are packed at the bottom of the tube, leaving the remainder of the blood (e.g., cell-free plasma) accessible in the top layer for further analysis. In these centralized settings, biomarker detection is then typically performed on large, complex analyzers capable of automated liquid handling and access to frequent validation of assay performance via calibration.

Point of care blood analyzers used outside a central lab also require removal of red blood cells prior to analysis. Access to intravenous quantities of blood and benchtop centrifugation is frequently not available or too time consuming in situations where a rapid result is required. Finger pricks provide blood volumes of around 5 microliters. Glucose test strips typically receive blood volumes less than 1 microliter and are subject to the interferences cited above. Removal of red blood cells from these small volumes remains a challenge.

### SUMMARY

In a first aspect, a method of separating red blood cells from blood is provided. The method includes obtaining a device including a microstructured substrate comprising a plurality of microstructures extending across a first surface of the microstructured substrate. At least a portion of an exterior surface of the plurality of microstructures are configured to allow capillary action. The device also includes a cover disposed a selected distance apart from a top of the first surface of the microstructured substrate and at least one sidewall that attaches the cover to the first surface of the microstructured substrate along a perimeter of the first surface of the microstructured substrate. Further, the device includes a first aperture defined by at least one of the microstructured substrate or the cover and a second aperture defined by at least one of the microstructured substrate or the cover. The first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume, and taking a total of the combined first open volume and second open volume to be 100% open volume, the first open volume has a larger percent of the 100% open volume than a volume percent of red blood cells that is present in the blood. The method further includes filling the device with a volume of blood through the first aperture via capillary action and waiting for a time sufficient for at least a portion of the red blood cells to settle within the first open volume of the plurality of microstructures. Additionally, the method includes applying pressure to the device, thereby causing at least 10% of the initial volume of blood, from which at least some of the red blood cells have been retained within the first open volume of the plurality of microstructures, to flow out of the device through either the first aperture or the second aperture.

In a second aspect, a device is provided. The device includes a microstructured substrate comprising a plurality of microstructures extending across a first surface of the microstructured substrate. The microstructures cover at least 90% of the first surface of the microstructured substrate and at least a portion of an exterior surface of the plurality of microstructures are configured to allow capillary action. The device also includes a cover disposed a selected distance apart from a top of the first surface of the microstructured substrate and at least one sidewall that attaches the cover to the first surface of the microstructured substrate along a perimeter of the first surface of the microstructured substrate. Further, the device includes a first aperture defined by at least one of the microstructured substrate or the cover and a second aperture defined by at least one of the microstructured substrate or the cover. The first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume.

In a third aspect, a method of separating solid particles from a fluid is provided. The method includes obtaining a device including a microstructured substrate comprising a plurality of microstructures extending across a first surface of the microstructured substrate. At least a portion of an exterior surface of the plurality of microstructures are configured to allow capillary action. The device also includes a cover disposed a selected distance apart from a top of the first surface of the microstructured substrate and at least one sidewall that attaches the cover to the first surface of the microstructured substrate along a perimeter of the first surface of the microstructured substrate. Further, the device includes a first aperture defined by at least one of the microstructured substrate or the cover and a second aperture defined by at least one of the microstructured substrate or the cover. The first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume. Taking a total of the combined first open volume and second open volume to be 100% open volume, the first open volume has a larger percent of the 100% open volume than a volume percent of particles that is present in the fluid. The method further includes filling the device with a volume of the fluid through the first aperture via capillary action and waiting for a time sufficient for at least a portion of the particles to settle within the first open volume of the plurality of microstructures. Additionally, the method includes applying pressure to the device, thereby causing at least 10% of the fluid, from which at least some of the particles have been retained within the first open volume of the plurality of microstructures, to flow out of the device through either the first aperture or the second aperture.

It has been discovered that devices and methods according to at least certain embodiments of this disclosure can provide removal of solid particles (e.g., red blood cells) from very small (e.g., microliter) volumes of fluids (e.g., blood).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a generalized flow chart of an exemplary method.

FIG. 2A is a perspective view of a generalized schematic diagram of an exemplary device.

FIG. 2B is a perspective view of a generalized schematic diagram of a microstructured substrate for use in an exemplary device.

FIG. 3A is a scanning electron microscopy (SEM) image of a cross-section of a portion of an exemplary device, marked up to illustrate part of an exemplary method.

FIG. 3B is an SEM image of the cross-section of the portion of the exemplary device of FIG. 3A, marked up to illustrate another part of an exemplary method.

FIG. 4A is a schematic cross-sectional view of a microstructured substrate having a plurality of ribs alternating with channels.

FIG. 4B is a schematic perspective view of a microstructured substrate having a plurality of ribs alternating with channels, in which the ribs include caps at their top surfaces.

FIG. 5A is a schematic cross-sectional view of a microstructured substrate having a linear array of prisms.

FIG. 5B is an SEM image of the cross-section of a portion of the exemplary device of Example 8.

FIG. 5C is a schematic perspective view of a portion of a microstructured substrate having an array of peak structures and adjacent valleys at a certain orientation.

FIG. 5D is a schematic perspective view of a portion of a microstructured substrate having an array of peak structures and adjacent valleys at another certain orientation.

FIG. 5E is a schematic cross-sectional view of a microstructured substrate having a facet structure.

FIG. 6A is a schematic cross-sectional view of a microstructured substrate that has a two-dimensional array of projections.

FIG. 6B is a top plan view of four representative engineered micropatterned regions for a two-dimensional array of projections.

FIG. 7A is a schematic cross-sectional view of a microstructured substrate having a plurality of cavities extending between two major surfaces.

FIG. 7B is generalized schematic exploded view of a microstructured substrate having a plurality of cavities extending between two major surfaces.

FIG. 8A is an exploded generalized schematic diagram of the device of Example 1.

FIG. 8B is a generalized schematic top view of the device of Example 1.

FIG. 8C are generalized schematic top views of two components used to attach a pump affixed to the device of Example 1.

FIG. 8D is a generalized schematic perspective view of the device of Example 1 adapted to be attached to a pump.

FIG. 9 is a generalized flow chart of another exemplary method.

FIG. 10A is a schematic perspective view of a portion of a microstructured substrate having an array of fluidically connected wells.

FIG. 10B is a schematic top view of a portion of a microstructured substrate having an array of fluidically connected wells having a circular shape.

FIG. 11 is a schematic cross-sectional view of a microstructured substrate having an array of generally upstanding stems.

While the above-identified figures set forth several embodiments of the disclosure other embodiments are also contemplated, as noted in the description. The figures are not necessarily drawn to scale. In all cases, this disclosure presents the invention by way of representation and not limitation.

### DETAILED DESCRIPTION OF ILLUSTRATIVE EMBODIMENTS

As used herein, the term “microreplication” means the production of a microstructured surface through a process where the structured surface features retain an individual feature fidelity during manufacture.

As used herein, the term “microstructure” encompasses both structures (i.e., features) that protrude above a major surface of a substrate, and structures that are recessed below a major surface of a substrate. Combinations of protruding and recessed features are contemplated. By a microstructure is further meant that the structure is a predetermined, molded structure (e.g., as obtained by molding a polymeric thermoplastic resin against a tooling surface that comprises the negative of the microstructure desired to be provided on a first major side of a substrate) with dimensions ranging from about 5 to about 3000 micrometers in at least two orthogonal directions. One of these orthogonal directions may often be normal to the plane of the substrate (e.g., along the z-axis,) thus this dimension can comprise, e.g., a protrusion height or a recess depth.

As used herein, the term “capillary action” refers to fluid flow absent the assistance of external forces (e.g., pressure, gravity, vacuum, etc.). Often capillary action occurs for an aqueous fluid in contact with a hydrophilic surface. An aqueous fluid comprises 50% or more by volume water.

As used herein, the term “hydrophilic” refers to a surface that is wet by aqueous solutions and does not express whether or not the material absorbs aqueous solutions. By “wet” it is meant that the surface exhibits spontaneous wicking when contacted with an aqueous fluid. By “spontaneous” it is meant occurring without external forces. In some embodiments, a hydrophilic surface exhibits an advancing (maximum) water contact angle of less than 90°, preferably 45° or less.

As used herein, the term “hydrophobic” refers to a surface that lacks spontaneous wicking when contacted with an aqueous fluid. In some embodiments, a hydrophobic surface exhibits an advancing water contact angle of 70° or greater, preferably 90° or greater.

As used herein, “curing” means the hardening or partial hardening of a composition by any mechanism, e.g., by heat, light, radiation, e-beam, microwave, chemical reaction, or combinations thereof. As used herein, the term “hardenable” refers to a material that can be cured or solidified, e.g., by heating to remove solvent, heating to cause polymerization, chemical crosslinking, radiation-induced polymerization or crosslinking, or the like. As used herein, “cured” refers to a material or composition that has been hardened or partially hardened (e.g., polymerized or crosslinked) by curing.

As used herein, a polymeric “film” is a polymer material in the form of a generally flat sheet that is sufficiently flexible and strong to be processed in a roll-to-roll fashion. By roll-to-roll, what is meant is a process where material is wound onto or unwound from a support, as well as further processed in some way. Examples of further processes include coating, slitting, blanking, and exposing to radiation, or the like. Polymeric films can be manufactured in a variety of thicknesses, ranging in general from about 5 micrometers to 1000 micrometers.

As used herein, “solid” refers to the state of matter that is not liquid or gas, and a solid has a stable three-dimensional shape.

As used herein, “fluid” refers to a composition that includes a liquid (i.e., the state of matter that is not solid or gas) and encompasses solutions, suspensions, and emulsions.

As used herein, “exterior surface” with respect to a microstructure refers to an outermost surface of the microstructure.

As used herein, “thermoplastic” refers to a polymer that flows when heated sufficiently above its glass transition point and become solid when cooled. In contrast, “thermoset” refers to a polymer that permanently sets upon curing and does not flow upon subsequent heating. Thermoset polymers are typically crosslinked polymers.

As used herein, the term “glass transition temperature” (T_{g}), of a polymer refers to the transition of a polymer from a glassy state to a rubbery state and can be measured using Differential Scanning Calorimetry (DSC), such as at a heating rate of 10° C. per minute in a nitrogen stream. When the T_{g} of a monomer is mentioned, it is the T_{g} of a homopolymer of that monomer. The homopolymer must be sufficiently high molecular weight such that the T_{g} reaches a limiting value, as it is generally appreciated that a T_{g} of a homopolymer will increase with increasing molecular weight to a limiting value. The homopolymer is also understood to be substantially free of moisture, residual monomer, solvents, and other contaminants that may affect the T_{g}. A suitable DSC method and mode of analysis is as described in Matsumoto, A. et. al., J. Polym. Sci. A., Polym. Chem. 1993, 31, 2531-2539.

As used herein, “transparent” refers to a material (e.g., a layer) that has at least 50% transmittance, 70% transmittance, or optionally greater than 90% transmittance over at least the 400 nanometer (nm) to 700 nm portion of the visible light spectrum.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

There is a need in point of care biomarker analysis for simple, efficient separation of red blood cells from microliter quantities of blood without hemolysis, dilution, or significant loss of blood to dead space.

In a first aspect, the present disclosure provides a method of separating red blood cells from blood. The method comprises:
a) obtaining a device comprising:
   1) a microstructured substrate comprising a plurality of microstructures extending across a first surface of the microstructured substrate, wherein at least a portion of an exterior surface of the plurality of microstructures are configured to allow capillary action;
   2) a cover disposed a selected distance apart from a top of the first surface of the microstructured substrate;
   3) at least one sidewall that attaches the cover to the first surface of the microstructured substrate along a perimeter of the first surface of the microstructured substrate;
   4) a first aperture defined by at least one of the microstructured substrate or the cover; and
   5) a second aperture defined by at least one of the microstructured substrate or the cover;
      wherein the first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume, and taking a total of the combined first open volume and second open volume to be 100% open volume, the first open volume has a larger percent of the 100% open volume than a volume percent of red blood cells that is present in the blood;
b) filling the device with a volume of blood through the first aperture via capillary action;
c) waiting for a time sufficient for at least a portion of the red blood cells to settle within the first open volume of the plurality of microstructures; and
d) applying pressure to the device, thereby causing at least 10% of the initial volume of blood, from which at least some of the red blood cells have been retained within the first open volume of the plurality of microstructures, to flow out of the device through either the first aperture or the second aperture.

In a second aspect, the present disclosure provides a device. The device comprises:
1) a microstructured substrate comprising a plurality of microstructures extending across a first surface of the microstructured substrate, wherein the microstructures cover at least 90% of the first surface of the microstructured substrate and wherein at least a portion of an exterior surface of the plurality of microstructures are configured to allow capillary action;
2) a cover disposed a selected distance apart from a top of the first surface of the microstructured substrate;
3) at least one sidewall that attaches the cover to the first surface of the microstructured substrate along a perimeter of the first surface of the microstructured substrate;
4) a first aperture defined by at least one of the microstructured substrate or the cover; and
5) a second aperture defined by at least one of the microstructured substrate or the cover;
wherein the first surface of the microstructured substrate together with the at least one sidewall defines a first open volume that is a total of open space located between the plurality of microstructures from a bottom to a top of each microstructure, wherein the cover together with the top of the first surface of the microstructured substrate and the at least one sidewall defines a second open volume located adjacent to the first open volume.

The below disclosure relates to both the first aspect and the second aspect.

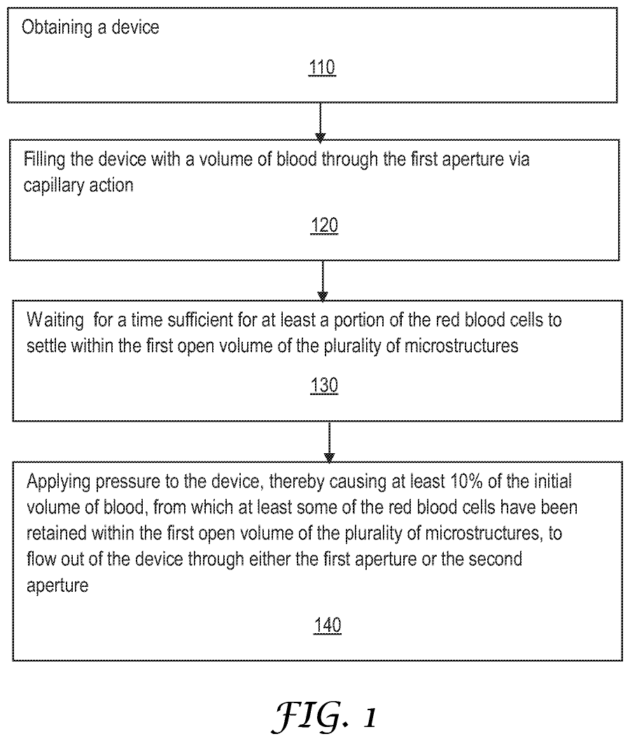

Referring to FIG. 1, the method comprises obtaining a device 110 (wherein the device is as described above); filling the device with a volume of blood through the first aperture via capillary action 120; waiting for a time sufficient for at least a portion of the red blood cells to settle within the first open volume of the plurality of microstructures 130; and applying pressure to the device, thereby causing at least 10% of the initial volume of blood, from which at least some of the red blood cells have been retained within the first open volume of the plurality of microstructures, to flow out of the device through either the first aperture or the second aperture 140. In some cases, the waiting time is sufficient for at least 15%, 20%, 25%, 30%, 35%, 40%, 45%, 50%, 55%, 60%, 65%, 70%, 75%, 80%, 85%, 90% or even at least 95% of the red blood cells to settle within the first open volume of the plurality of microstructures.

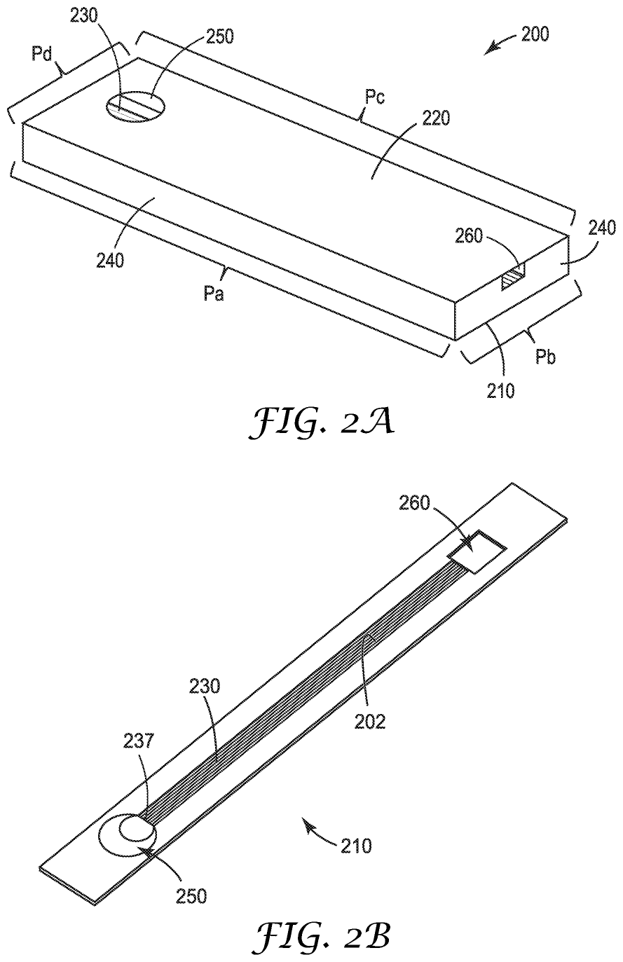

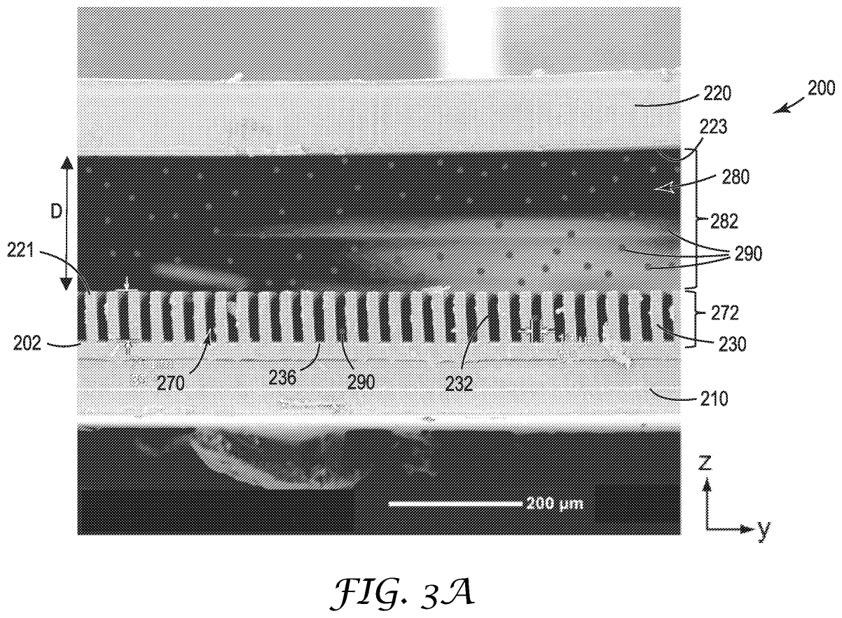

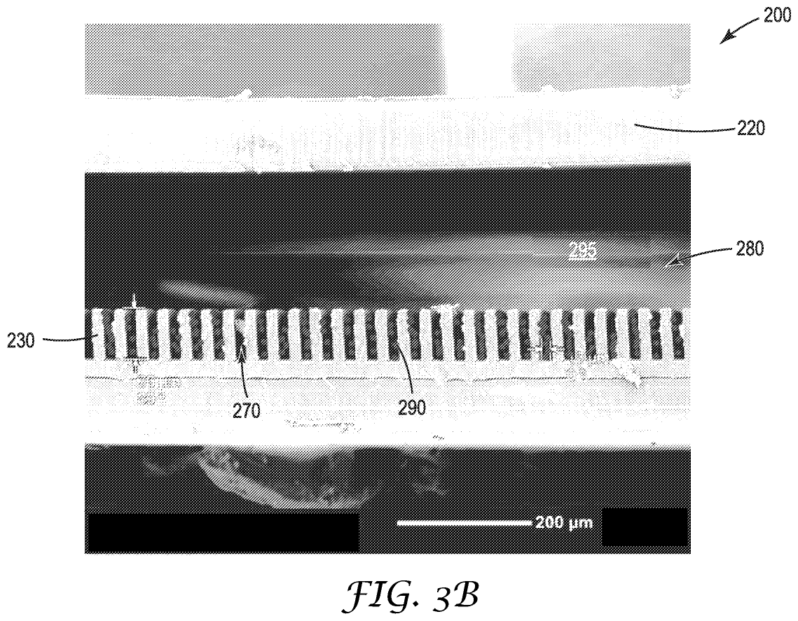

Referring to FIGS. 2 and 3A, an exemplary device 200 is illustrated. The device 200 comprises a microstructured substrate 210 comprising a plurality of microstructures 230 extending across a first surface 202 of the microstructured substrate 210. At least a portion of an exterior surface 232 of the plurality of microstructures 230 are configured to allow capillary action. The device 200 also includes a cover 220 disposed a selected distance D apart from a top of the first surface 221 of the microstructured substrate 210 and at least one sidewall 240 that attaches the cover 220 to the first surface 202 of the microstructured substrate 210 along a perimeter P of the first surface of the microstructured substrate 210. The perimeter P is collectively made up of each side Pa, Pb, Pc, Pd, . . . Pn, of the particular device. The device 200 shown in FIG. 2A has four sides, Pa, Pb, Pc, and Pd, thus the perimeter P includes each of those four sides. Other shapes of devices are contemplated that have a different number of sides than four.

Optionally, the at least one sidewall 240 may comprise an adhesive layer that is disposed between the cover 220 and the microstructured substrate 210 (e.g., that attaches the cover to the substrate), for instance a double-sided tape as used in Example 1 below. This may be particularly useful when the microstructured substrate is a microstructured film. Suitable materials for the adhesive layer include for instance a pressure-sensitive adhesive. The adhesive layer can be made by coating a film of an adhesive containing an adhesive polymer. Preferably, the adhesive comprises an adhesive polymer and a crosslinking agent. The term “adhesive polymer” used herein refers to a polymer which exhibits adhesion at ambient temperature (e.g., 20-25° Celsius). The adhesive polymer may be, for example, acrylic polymer, polyurethane, polyolefin, or polyester. In select embodiments, the adhesive layer comprises a double coated adhesive film. Some suitable commercially available double coated adhesive films are from 3M Company (St. Paul, MN) under the trade designations 3M Medical Silicone Tape 2477P and each of 3M Medical Tape 1509, 1510, 1513, 1522, 9874, and 9877.

Further, the device includes a first aperture 250 defined by at least one of the microstructured substrate 210 or the cover 220 and a second aperture 260 defined by at least one of the microstructured substrate 210 or the cover 220. The device shown in FIG. 2A includes a first aperture 250 that is defined by the cover 220 and a second aperture 260 that is defined by both the microstructured substrate 210 and the cover 220.

In select embodiments, the sidewall, microstructured substrate, and cover are hermetically sealed to each other at their points of contact (e.g., seams), which minimizes leakage of fluid sample out any seam between the three (e.g., fluid may enter and exit primarily or solely through the first aperture and/or the second aperture). In some cases, the microstructured substrate itself includes a sidewall in its structure such that the at least one sidewall is a portion of the microstructured substrate.

Suitable materials for use as the cover include for instance and without limitation, a polyolefin (e.g., high density polyethylene (HDPE), medium density polyethylene (MDPE), or low density polyethylene (LDPE)), a polyester, a polyamide, a poly(vinyl chloride), a polyether ester, a polyimide, a polyesteramide, a polyacrylate, a polyvinylacetate, or a hydrolyzed derivative of polyvinylacetate. In certain embodiments, polyolefins are preferred because of their excellent physical properties, ease of processing, and typically low cost. Also, polyolefins are generally tough, durable and hold their shape well, thus being easy to handle after article formation. In select embodiments, the film layer includes the polyester polyethylene terephthalate (PET). One suitable commercially available PET is a 5 mil (127 micrometer) thick PET sheet from Tekra (New Berlin, WI) under the trade designation “MELINEX 454”. A suitable commercially available LDPE is from The Dow Chemical Company (Midland, MI) under the trade designation “DOW 9551 LDPE”. Further, various additives may be included in the cover layer, for example surface energy modifiers (such as surfactants and hydrophilic polymers), plasticizers, antioxidants, pigments, release agents, antistatic agents, and the like.

The first surface 202 of the microstructured substrate 210 together with the at least one sidewall 240 defines a first open volume 270 that is a total of open space located between the plurality of microstructures 230 from a bottom 236 to a top 221 of each microstructure 230. (For simplicity, the arrow for 270 just points to a portion of the first open volume between two adjacent microstructures 230). The cover 220 together with the top 221 of the first surface 202 of the microstructured substrate 210 and at least one sidewall 240 defines a second open volume 280 located adjacent to the first open volume 270, and taking a total of the combined first open volume and second open volume to be 100% open volume, the first open volume has a larger percent of the 100% open volume than a volume percent of red blood cells that is present in the blood. To tailor a device to blood containing a particular volume percent of (e.g., solid) particles such as red blood cells, it can be determined that considering a total of the combined first open volume and second open volume to be 100% open volume, the first open volume needs to have a larger percent of the 100% open volume than a volume percent of particles that is present in the fluid. For instance, if the volume percent of particles is 20% of the total volume of the fluid, a suitable ratio of the first open volume to the second open volume would be greater than 1:4 (e.g., 1.1:4). If the volume percent of particles is 75% of the total volume of the fluid, a suitable ratio of the first open volume to the second open volume would be greater than 3:1 (e.g., 3.1:1).

In some cases, a ratio of the first open volume 270 to the second open volume 280 is 1:1 or greater, 1.1:1, 1.2:1, 1.3:1, or 1.4:1 or greater; and up to 2.0:1, 1.9:1, 1.8:1, 1.7:1, 1.6:1, or up to 1.5:1. The bracket 272 indicates the height of the first open volume 270 and the bracket 282 indicates the height of the second open volume 280, plus indicates that in this device 220 the second volume 280 is stacked directly on top of the first open volume 270 when the device 220 is oriented as shown by the z and y axes. It is noted that the device 200 in FIGS. 3A and 3B is not to scale for a ratio of first open volume 270 to second open volume 280 of 1:1 or greater, and is shown to assist in the descriptions of devices and methods provided herein.

Optionally, it may also be useful to select a specific relationship (e.g., a ratio) between an average height of the plurality of microstructures and an average width of a pitch between each of the plurality of microstructures. Preferably, the first open volume is sufficiently large that if all the red blood cells settle, there should not be red blood cells that protrude above the tops of the microstructures.

As noted above, at least a portion of an exterior surface of the plurality of microstructures are configured to allow capillary action. Capillary action is well known in the art to refer to fluid flow absent the assistance of external forces, typically for an aqueous fluid (having 50% or more by volume water) in contact with a hydrophilic surface. Accordingly, once blood is introduced into the first aperture of the device, the blood is spontaneously transported along the exterior surfaces of the microstructures, thereby spreading out within the area of the microstructures. Two general factors that influence the ability of microstructures to spontaneously transport fluids are (i) the structure or topography of the surface (e.g., capillarity, shape of the cavity) and (ii) the nature of the surface (e.g., surface energy). To achieve the desired amount of fluid transport capability a designer may adjust the structure or topography of the substrate layer and/or adjust the surface energy of the capillary microstructured surfaces. In order to achieve wicking, a surface of the capillary microstructures must be capable of being “wet” by the liquid (e.g., liquid state of matter) to be transported. Optionally, the susceptibility of a solid surface to be wet by a liquid is characterized by the contact angle that the liquid makes with the solid surface after being deposited on a horizontally disposed surface and allowed to stabilize thereon. This angle is sometimes referred to as the “static equilibrium contact angle,” and sometimes referred to herein merely as “advancing contact angle.” In some cases, a material is considered hydrophilic if it has an advancing contact angle of less than 90 degrees, whereas a hydrophilic surface exhibits an advancing (maximum) water contact angle of less than 90°, preferably 450 or less.

Enough of the exterior surfaces of the microstructures need to be hydrophilic to make the microstructured substrate capable of capillary action to transport the fluid (e.g., blood) throughout the device once the fluid has been introduced via the first aperture such that the solid particles can have access to the open volume between microstructures to be able to settle out of the bulk of the fluid. In some cases, 50% or more of the area of the exterior surface of the microstructures is capable of capillary action, 60%, 70%, 80%, 90%, or 95% or more of the exterior surface of the microstructures is capable of capillary action. In select embodiments, at least a portion of a major surface 223 of the cover 220 that faces the microstructured substrate 230 is hydrophilic, to assist in the capillary action of the fluid inside the device 200. Hydrophilicity of the exterior surface of the microstructures and/or a major surface of the cover, according to any device described herein, can be achieved through one or more of material selection, additives included in the material, or surface treatment. In some embodiments, the microstructures have an exterior surface including a surfactant, a surface treatment, a hydrophilic polymer, a flocculant, or any combination thereof. Suitable surfactants include for instance and without limitation, C8-C18 alkane sulfonates; C8-C18 secondary alkane sulfonates; alkylbenzene sulfonates; C8-C18 alkyl sulfates; alkylether sulfates; sodium laureth 4 sulfate; sodium laureth 8 sulfate; dioctylsulfosuccinate, sodium salt; lauroyl lacylate; stearoyl lactylate; or any combination thereof. One or more surfactants can be applied by conventional methods, such as by wiping a coating of the surfactant on the surface of the microstructures and allowing the coating to dry. A suitable surface treatment includes a hydrophilic coating comprising plasma deposited silicon/oxygen materials and/or diamond-like glass (DLG) materials. Plasma deposition of each of silicon/oxygen materials and DLG material is described, for instance, in PCT Publication No. WO 2007/075665 (Somasiri et al.). Further, examples of suitable DLG materials are disclosed in U.S. Pat. No. 6,696,157 (David et al.), U.S. Pat. No. 6,881,538 (Haddad et al.), and U.S. Pat. No. 8,664,323 (Iyer et al.). Suitable hydrophilic polymers include for instance and without limitation, a polyester, a polyamide, a polyurethane, a poly(vinyl alcohol), a poly(alkylene glycol), a poly(alkylene oxide), a poly(vinyl pyrrolidone), a rubber elastomer, or any combination thereof.

The use of certain ionic polymers, especially cationic polymers, for the flocculation of cell and/or cell debris, as well as for the precipitation of proteins, is known. When a flocculant is used, a device may be used that has larger microstructures (e.g., height and/or depth, pitch between adjacent microstructures, etc.) than when no flocculant is used. This is due to the particles tending to clump and have larger sizes when flocculated, such that a larger space may be needed to hold the particles within the microstructures. In contrast, a device having large microstructures may be less effective in retaining particles (e.g., red blood cells) separated from the fluid (e.g., blood) that have not been flocculated. As such, the microstructured surface of a device may be selected in part by taking into account the expected size of the particles or flocculated particles.

The polymers used as flocculants may be unmodified (e.g., polyethyleneimine) or modified (e.g., guanylated polyethyleneimine). In some embodiments, a suitable flocculant is hydrophilic and non-hemolytic (i.e., does not lyse red blood cells). Some suitable floccul'ants are as described in detail in U.S. Pat. No. 8,435,776 (Rasmussen et al.) and U.S. Pat. No. 10,005,814 (Rasmussen et al.), incorporated herein by reference in their entireties. In certain cases, the flocculant comprises an unmodified or modified (e.g., functionalized) aminopolymer. Suitable aminopolymers, for instance, may be selected from the group consisting of polyethylenimine, polylysine, polyaminoamides, polyallylamine, polyvinylamine, polydimethylamine-epichlorohydrin-ethylenediamine, polydiallyldimethylammonium chloride, cationic polyacrylamide (CPAM), polyaminosiloxanes, and dendrimers formed from polyamindoamine (PAMAM) and polypropylenimine. Suitable modified aminopolymers can be prepared by functionalizing one or more aminopolymers selected from the group consisting of polyethylenimine, polylysine, polyaminoamides, polyallylamine, polyvinylamine, polydimethylamine-epichlorohydrin-ethylenediamine, polydiallyldimethylammonium chloride, CPAM, polyaminosiloxanes, and dendrimers formed from PAMAM and polypropylenimine. For example, the functionalization may include reacting the aminopolymer with an alkylating, acylating, or guanylating agent. In select embodiments, the flocculant comprises a modified or unmodified polyethylenimine polymer.

One or more flocculants can be applied by conventional methods, such as by applying a coating of the flocculant on the surface of the microstructures and allowing the coating to dry.

In some cases, the flocculant has a weight average molecular weight (Mw), as determined by gel permeation chromatography, of 5,000 grams per mole (g/mol) or greater, 10,000 g/mol, 20,000 g/mol, 30,000 g/mol, 40,000 g/mol, 50,000 g/mol, 60,000 g/mol, 70,000 g/mol, 80,000 g/mol, 90,000 g/mol, 100,000 g/mol, 110,000 g/mol, 120,000 g/mol, 130,000 g/mol, 140,000 g/mol, or 150,000 g/mol or greater; and 500,000 g/mol or less. Sometimes a high molecular weight e.g., 50,000 g/mol or greater, can be helpful in flocculating particles (e.g., red blood cells).

Advantageously, at least some of the flocculant tends to dissolve, disperse, or a combination thereof into the fluid (e.g., blood) following the filling of the device with the volume of fluid. In some cases, the amount of flocculant employed is designed to result in a concentration of flocculant in the volume of fluid sample (e.g., blood) in an amount of 0.01 micrograms per milliliter (μg/mL) of fluid or greater, 0.1 μg/mL, 0.25 μg/mL, 0.5 μg/mL, 1 μg/mL, 5 μg/mL, 10 μg/mL, 25 μg/mL, 50 μg/mL, 75 μg/mL, 100 μg/mL, 150 μg/mL, 250 μg/mL, 500 μg/mL, 750 μg/mL, 1000 μg/mL, or 1500 μg/mL or greater; and 5000 μg/mL or less, 4000 μg/mL, 3000 μg/mL, 2000 μg/mL, 1000 μg/mL, 500 μg/mL, 200 μg/mL, 100 μg/mL, 50 μg/mL, 10 μg/mL, or 2 μg/mL or less. Stated another way, in some embodiments the flocculant is present in a volume of fluid (e.g., blood) in an amount of 0.01 μg/mL to 5000 μg/mL. The amount of flocculant when in a form of a dried coating on a surface of the device will vary based on the molecular weight (Mw) of the particular flocculant.

FIGS. 3A and 3B also incorporate a cartoon depiction on the SEM image of a device to illustrate the concept of how the device 200 is typically used. For instance, after blood 295 has been filled into the device 200, using capillary action, red blood cells 290 begin settling between the microstructures 230 into the first open volume 270. In FIG. 3A, only three red blood cells 290 are depicted as being located in the first open volume 270. Referring to FIG. 3B, the device 200 is depicted after waiting for a time sufficient for all of the red blood cells 290 to settle within the first open volume 270 of the plurality of microstructures 230. Often, the red blood cells settle solely due to gravity. A volume of blood 295 from which the red blood cells have been removed is present in the second open volume 280. In use, upon application of pressure to the device, some amount of the initial volume of blood, from which at least some of the red blood cells have been retained within the first open volume 270 of the plurality of microstructures 230, is caused to flow out of the device through either the first aperture 250 or the second aperture 260. In some cases, it is preferred for the blood 295 to exit out of the second aperture 260.

Optionally, the method further includes passing the fluid (e.g., blood) through a filter before entering the device, after exiting the device, or both. For example, filtering the fluid may be useful to remove at least one undesirable component from the fluid. Suitable filters include for instance and without limitation, a nonwoven filter, a woven filter, a membrane filter, a paper filter, and a sponge filter. Exemplary suitable filters include, for example, a glass fiber filter, and an asymmetric polysulfone/polyethersulfone filter (e.g., such as the VIVID Plasma Separation membranes commercially available Pall Corporation (Port Washington, NY), or the Cobetter OneStep Plasma Separation Membrane or the Cobetter RB series, both commercially available from Cobetter Filtration Equipment Co., Ltd. (Hangzhou, China)).

In some cases, a method further comprises adding a flocculant to the volume of fluid (e.g., blood) before filling the device with the volume of fluid (e.g., blood). The flocculant may be as described in detail above, including the concentration present in the volume of fluid (e.g., an amount of 0.01 to 5000 micrograms/mL of fluid).

Red blood cells tend to make up 35 to 50% of the total volume of whole blood. Having the ratios of first open volume to second open volume of 1:1 or greater provides sufficient room within the first open volume amongst the microstructures for up to all of the red blood cells of an undiluted whole blood sample to be retained while leaving the second open volume free for blood that contains fewer (to no) red blood cells. As such, when pressure is applied to the device following settling, blood from which red blood cells has been removed (in some cases plasma) preferentially exits the device as it is located closer to the apertures. In contrast, the settled red blood cells tend to be held between the microstructures within the first open volume and less available to be removed from the device with the application of pressure. In some cases, the ratio of the first open volume to the second open volume is selected to minimize a volume of blood that can settle in the first open volume with the red blood cells, in order to maximize a volume of blood (from which red blood cells have been removed) that can be flowed from the device for analysis. By selecting a ratio of first open volume to second open volume of 1:1 or greater, it is typically not necessary to dilute whole blood for effective separation of red blood cells from the blood such that the blood may be used in undiluted form. However, it is possible to use a smaller ratio with diluted blood, such as 0.9:1 or less, 0.8:1, 0.7:1, 0.6:1, or even 0.5:1 or less.

Advantageously, devices according to at least certain embodiments of the present disclosure effectively separate (at least a portion of) red blood cells from a small volume of blood while minimizing retention of analyzable blood within the device. This is in contrast to devices that employ a flow stream or result in dead volume losses. Examples of red blood separator devices that require flowing blood include US Application Publication No. 2008/0135502 (Pyo et al.), U.S. Pat. No. 11,262,347 (Yun et al.), U.S. Pat. No. 10,518,196 (Puleo et al.), KR 2010/0048507 (Chun et al.), and TW 1338134 (Chou et al.).

Preferably, at least 10%, 15%, 20%, 25%, 30%, 35% or even at least 40% of the blood from which red blood cells have been removed is caused to flow out of the device upon the application of pressure. The greater the percentage, the greater the efficiency of the separation method using a device according to the present disclosure and the less analyzable sample volume is lost in the device.

Devices according to at least certain embodiments of the present disclosure are suitable for use to remove solid particles (e.g., red blood cells) from a fluid (e.g., blood) when a sample volume is 120 microliters or less, 110 microliters, 100 microliters, 90 microliters, 80 microliters, 70 microliters, 60 microliters, 50 microliters, 40 microliters, 30 microliters, 20 microliters, 10 microliters, or even 5 microliters or less; and 1 microliter or more, 2 microliters, 3 microliters, 4 microliters, 5 microliters, 6 microliters, 7 microliters, 8 microliters, 9 microliters, 10 microliters, 12 microliters, 15 microliters, 25 microliters, 35 microliters, or 45 microliters or more. For instance, a total of the first open volume and the second open volume of a device may be between 5 microliters and 120 microliters.

In some cases, a first aperture is defined by the cover of the device and a volume of fluid (e.g., blood) can be introduced into the device using gravity and/or wicking the fluid into the aperture. In other cases, a first aperture is defined by the microstructured substrate. For example, referring to FIG. 2B, the first aperture 250 may be provided as a reservoir configured to hold at least a certain minimum volume of fluid. The reservoir may be defined by a portion of the microstructured substrate 210 that is adjacent to one end 237 of the microstructures 230. Likewise, the second aperture 260 may be a reservoir configured to hold fluid as it exits the microstructured surface 202 of the microstructured substrate 210. Often, it is advantageous for the second aperture to be located a distance away from the first aperture to readily allow venting of displaced gas (typically air) from the device as the fluid is deposited into the device via the first aperture. Optionally, positive pressure can be provided by a pump to deposit a volume of blood in the first aperture, then after at least some of the red blood cells have settled into the first open volume the pump can be engaged again to urge blood from the second open volume out of the second aperture. Optionally, a volume of blood can be wicked into the device through the first aperture, then either positive pressure provided by a user's finger or negative pressure provided by a vacuum source can be used to urge blood from the second open volume out of either the first aperture or the second aperture. As such, the pressure that causes blood (from which some red blood cells have been removed) may be positive pressure or negative pressure.

### Louver Structure

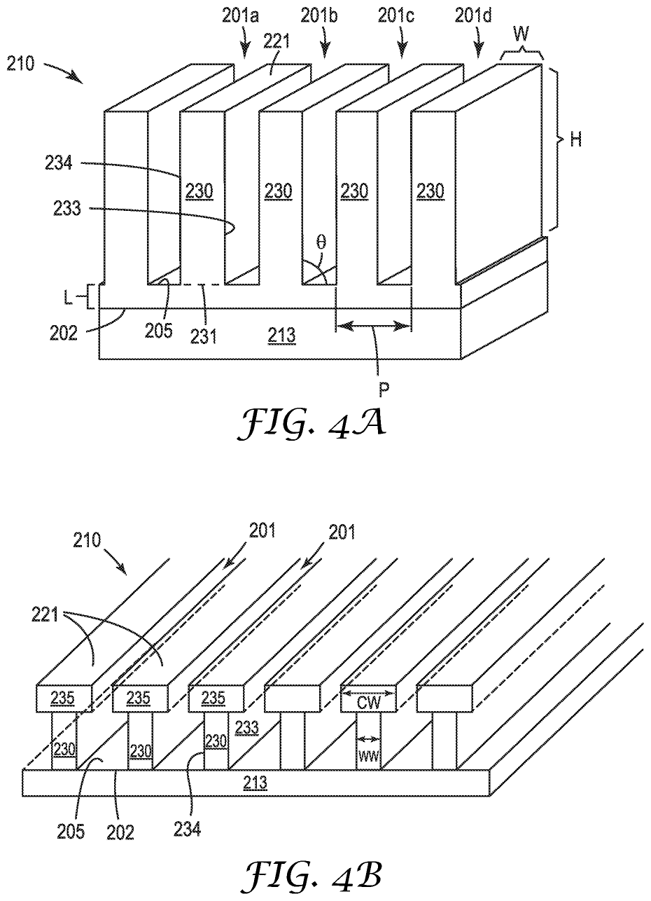

Referring again to FIGS. 3A and 3B, the microstructures 230 of the device of certain embodiments comprise a “louver structure”, which comprises ribs separated by channels. This shape is also illustrated in FIG. 4A, in which the microstructures 230 comprise plurality of ribs 230 alternated with channels 201 extending across the first surface 202 of the microstructured substrate 210 and wherein each of the ribs 230 comprises side walls 233 and 234 and a top surface 221 and each of the channels 201 comprises a bottom surface 205.

More particularly, the depicted microstructured substrate 210 comprises a plurality of channels 201a-201d on a base layer 213. As shown in FIG. 4A, a continuous land layer “L” can be present between the bottom of the channels 205 and the top surface 202 of the base layer 213. Alternatively, the channels 201 can extend all the way through the microstructured substrate 210. In some cases (as shown in FIG. 4B), the bottom surface 205 of the groove can be coincident with the top surface 202 of a base layer 213. In typical embodiments, the base layer 213 is a preformed film that comprises a different organic polymeric material than the ribs 230.

The height and width of ribs (e.g., protrusions) 230 are defined by adjacent channels (e.g., 201a and 201b). The ribs 230 can be defined by a top surface 221, a bottom surface, 231, and side walls 233 and 234 that join the top surface 221 to the bottom surface 231. The side walls 233 and 234 can be parallel to each other. More typically the side walls have a wall angle.

The ribs 230 can be defined by a width “W”. Often, the ribs 230 have a width parallel to the first surface of the microstructured substrate and a height orthogonal to the first surface of the microstructured substrate. Excluding the land region “L”, the ribs 230 typically have nominally the same height as the channels 201. In typical embodiments, the height “H” of the channels 201 and/or the ribs 230 is at least 10, 20, 30, 40, 50, 60, 70, 80, 90 or 100 micrometers. In some embodiments, the height is no greater than 500, 475, 450, 425, 400, 375, 350, 325, 300, 275, 250, 240, 230, 220, 210, 200, 190, 180, 170, 160, 150, 140, 130, 120, 110, or 100 micrometers. In some embodiments, the height of the channels 201 and/or the ribs 230 ranges from 50 to 500 micrometers. The microstructured substrate typically comprises a plurality of ribs 230 having nominally the same height and width. In some embodiments, the ribs 230 have a height, “H”, a maximum width at its widest portion, “W”, and an aspect ratio, H/W, of at least 1.5. In some embodiments, H/W is at least 1.75, 2.0, 2.25, 2.5, 2.75, 3.0, 3.5, 4.0, 4.5 or 5.0. In other embodiments, the aspect ratio of the ribs is at least 6, 7, 8, 9, or 10. In other embodiments, the aspect ratio of the ribs is at least 15, 20, 25, 30, 35, 40, 45, or 50.

Channels 201 have a height “H” defined by the distance between the bottom surface 205 and top surface 221, such top and bottom surfaces typically being parallel to the top surface 202 of a base layer 213. The channels 201 have a maximum width “W” and are spaced apart along microstructured surface 202 by a pitch “P”. The width of the channels “W”, at the base (i.e., adjacent to bottom surface 205) is typically nominally the same as the width of the channels adjacent the top surface 221. However, when the width of the channels at the base differs from the width adjacent the top surface, the width is defined by the maximum width. The maximum width of a plurality of channels can be averaged for an area of interest, such as an area for calculating the first open volume. The microstructured substrate may comprise a plurality of channels having nominally the same height and width. In typical embodiments, the channels generally have a width no greater than 50, 40, 30, 20, 10, 9, 8, 7, 6, 5, 4, 3, 2, or 1 micrometer. In some embodiments, the channels generally have a width no greater than 900, 800, 700, 600, or 500 micrometers. In some embodiments, the channels have a width of at least 50, 60, 70, 80, 90, or 100 micrometers.

In some embodiments, a wall angle θ is greater than 90, 91, 92, 93, 94, 95, 96, 97, 98, 99, or 100 degrees. In some embodiments, the wall angle is no greater than 110, 109, 108, 107, 106, 105, 104, 103, 102, 101, 100, 99, 98, 97, 96, or 95 degrees. In some embodiments, the wall angle is approaching 90 degrees. When the wall angle is 90 degrees, the angle between the channels 201 and top surface 221 is also 90 degrees. Depending on the wall angle, the ribs can have a rectangular or trapezoidal cross-section. In some embodiments, the side walls can be described as comprising first and second side walls, in which the first side wall has a wall angle with a line that is parallel to the first surface of the microstructured substrate from 0 degrees to +10 degrees or from 0 degrees to −10 degrees relative to the bottom surface of the microstructured substrate.

In some embodiments, the ribs 230 have a pitch, “P” of at least 10 micrometers. The pitch is the distance between the onset of a first rib and the onset of a second rib as depicted in FIG. 4A. The pitch may be at least 15, 20, 25, 30, 35, 40, 45, or 50, 60, or 70 micrometers. The pitch is generally no greater than 1 mm. The pitch is typically no greater than 900, 800, 700, 600, or 500 micrometers. In some embodiments, the pitch is typically no greater than 550, 500, 450, 400, 350, 300, 250 or 200 micrometers. In some embodiments, the pitch is no greater than 175, 150, 100 micrometers. In typical embodiments, the ribs are evenly spaced, having a single pitch. Alternatively, the ribs may be spaced such that the pitch between adjacent ribs is not the same. In this later embodiment, at least some and typically the majority (at least 50, 60, 70, 80, 90% or greater of the total ribs) have the pitch just described. The pitch of the channels is within the same range as just described for the ribs. Optionally, the channels have an average pitch of 10 to 200 micrometers. The pitch and height of the ribs can be important to facilitate coating of the ribs with a coating. When the ribs are spaced too close together it can be difficult to uniformly coat the side walls. When the ribs are spaced too far apart, the coating may not be effective at providing its intended functions.

A variation to the louver structure of FIG. 4A is depicted in FIG. 4B, where in some cases, the top surface 221 of each rib 230 is the top of a cap 235 disposed on the side walls 233, 234 and the cap 235 has a width (“CW”) greater than a width between opposing side walls 233 and 234 (“WW”). Without wishing to be bound by theory, it is believed that the presence of the caps on the ribs (e.g., undercut features) may assist is retaining particles in the channels once the particles have settled in a device.

A louver structure can be prepared by any suitable method. In one embodiment, a structure, e.g., the microstructured substrate 210 shown in FIG. 4A, can be prepared by a method including the steps of (a) preparing a polymerizable composition; (b) depositing the polymerizable composition onto a master negative microstructured molding surface (e.g., tool) in an amount barely sufficient to fill the cavities of the master; (c) filling the cavities by moving a bead of the polymerizable composition between a (e.g., preformed film) base layer and the master, at least one of which is flexible; and (d) curing the composition. The deposition temperature can range from ambient temperature to about 180° F. (82° C.). The master can be metallic, such as nickel, chrome- or nickel-plated copper or brass, or can be a thermoplastic material that is stable under the polymerization conditions and has a surface energy that allows clean removal of the polymerized material from the master. When the base layer is a preformed film, one or more of the surfaces of the film can optionally be primed or otherwise be treated to promote adhesion with the organic material of the microstructures.

In one embodiment, a structure, e.g., the microstructured substrate 210 shown in FIG. 4B having caps on the ribs, can be prepared by methods known to make undercut features (e.g., partially disassembling a mold that is made of multiple parts after molding, thus opening each of the cavities and allowing the feature to be easily removed; or by first molding straight ribs with no undercut, and then capping those stems in a separate shaping step after demolding). Alternatively, such microstructured substrates may be make according to the disclosure of PCT Publication No. WO 2015/041844 (Rule et al.), in which a polyolefin resin is deposited into a mold cavity to form a first layer including a plurality of undercut features on and extending from an integral backing and demolding the first layer from the mold cavity at a rate of at least 150 millimeters per minute (mm/min).

The polymerizable resin can comprise a combination of a first and second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition can comprise a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof.

The polymerizable resin can be a radiation curable polymeric resin, such as a UV curable resin. In some cases, polymerizable resin compositions useful for the microstructured substrates of the present disclosure can include polymerizable resin compositions such as are described in U.S. Pat. No. 8,012,567 (Gaides et al.).

The chemical composition and thickness of the base layer can depend on the end use of the microstructured substrate. In typical embodiments, the thickness of the base layer can be at least about 0.025 millimeters (mm) and can be from about 0.05 mm to about 0.25 mm. Useful base layer materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefin-based material such as cast or orientated films of polyethylene, polypropylene, and polycyclo-olefins, polyimides, and glass. Optionally, the base layer can contain mixtures or combinations of these materials. In some embodiments, the base layer may be multi-layered or may contain a dispersed component suspended or dispersed in a continuous phase.

Examples of base layer materials include polyethylene terephthalate (PET) and polycarbonate (PC). Examples of useful PET films include photograde polyethylene terephthalate, available from DuPont Films of Wilmington, Del. under the trade designation “Melinex 618”. Examples of optical grade polycarbonate films include LEXAN polycarbonate film 8010, available from GE Polymershapes, Seattle, WA, and Panlite 1151, available from Teijin Kasei, Alpharetta, GA.

Alternatively, the microstructured substrate 210 can be prepared by melt extrusion, i.e., casting a fluid resin composition onto a master negative microstructured molding surface (e.g., tool) and allowing the composition to harden. In this embodiment, the ribs 230 are interconnected in a continuous layer to base layer 213. The individual ribs and connections therebetween generally comprise the same thermoplastic material. The thickness of the land layer (i.e., the thickness excluding that portion resulting from the replicated microstructure) is typically between 0.001 and 0.100 inches and preferably between 0.003 and 0.010 inches. Suitable resin compositions for melt extrusion are transparent materials that are dimensionally stable, durable, weatherable, and readily formable into the desired configuration. Examples of suitable materials include acrylics, such as Plexiglas brand resin manufactured by Rohm and Haas Company (Philadelphia, PA); polycarbonates; reactive materials such as thermoset acrylates and epoxy acrylates; polyethylene based ionomers, such as those marketed under the brand name of SURLYN by Dow Chemical (Midland, MI) E. I. Dupont de Nemours and Co., Inc.; (poly)ethylene-co-acrylic acid; polyesters; polyurethanes; and cellulose acetate butyrates.

In yet another embodiment, the master negative microstructured molding surface (e.g., tool) can be employed as an embossing tool, such as described in U.S. Pat. No. 4,601,861 (Pricone).

Further details regarding microstructured substrates having such louver structures and how to form them are described in WO 2019/118685 (Schmidt et al.) and WO 2020/026139 (Schmidt et al.), each incorporated herein by reference.

### Prism Structure

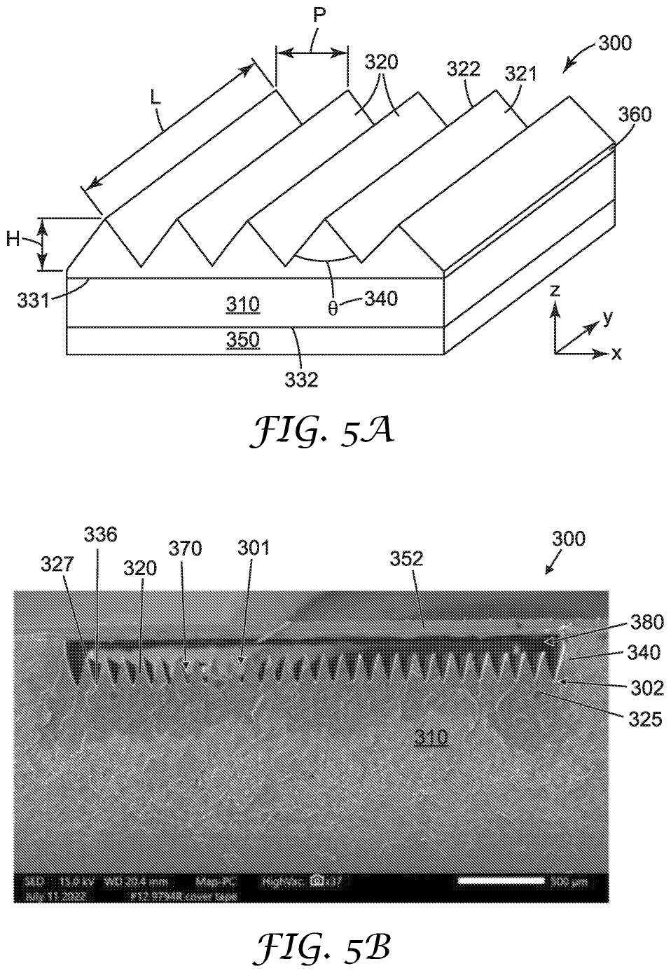

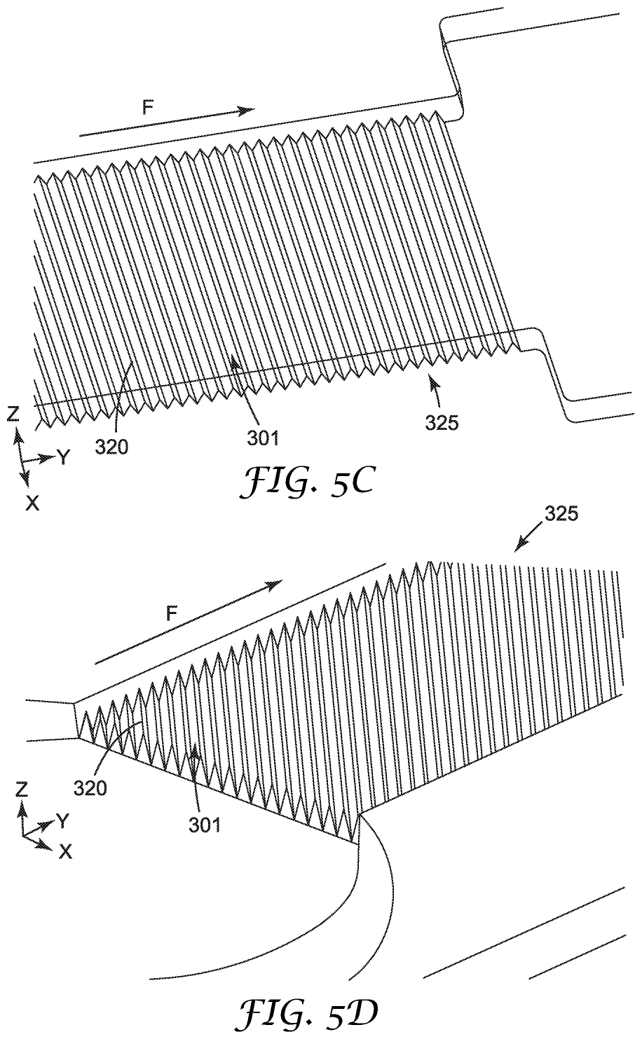

FIG. 5A shows an alternative microstructured substrate 309 comprising a linear array of regular prisms 320. Each prism has a first facet 321 and a second facet 322. The prisms are typically formed on a (e.g., preformed polymeric film) base member 310 that has a first planar surface 331 on which the prisms are formed and a second surface 332 that is substantially flat or planar and opposite first surface. In some embodiments, the prisms are right prisms. By right prisms it is meant that the apex angle θ, 340, is typically about 90°. However, this angle can range from 5° to 90° and may range from 20° to 80°. In select embodiments, the microstructures comprise linear prisms having an apex angle of less than or equal to 90 degrees. In some embodiments, the apex angle of the peak structure is typically two times the wall angle, particularly when the facets of the peak structures are interconnected at the valleys between peak structures. Thus, the apex angle is typically greater than 5 degrees and more typically at least 25, 30, 35, 40, 45, 50, 55, or 60 degrees. The apex angle of the peak structure is typically less than 90 degrees and more typically less than 85, 80, 75, 70, 65, 60, 55, 50, 45, 40, or 35 degrees. Optionally, there are gaps in between adjacent peak structures 320, e.g., at or parallel to the first planar surface 331.

These apexes can be sharp (as shown), rounded, or truncated. In some cases, it is advantageous to use sharp or rounded apexes due to a lower likelihood of particles settling on top of such shapes than a truncated (e.g., flat) shape. Preferably, the radius of the prism tip is smaller than the radius of the particle (e.g., red blood cell). The spacing between (e.g., prism) peaks may be characterized as pitch (“P”). In this embodiment, the pitch is also equal to the maximum width of the valley. Thus, the pitch is greater than 1, 2, 3, 4, 5, 6, 7, 8, 9, or 10 microns ranging up to 500 microns, as previously described. The length (“L”) of the prism microstructures is typically the largest dimension and can span the entire dimension of the microstructured surface, film or article. The prism facets need not be identical and the prisms may be tilted with respect to each other. The facets of adjacent peak structures are typically connected at the bottom of the valley, i.e., proximate the planar base layer. The facets of the peak structures form a continuous surface in the same direction. For example, in FIG. 5A, the facets 321 and 322 of the prism peak structures are continuous in the direction of the length (L) of the microstructures or in other words, the y-direction.

Optionally, a continuous land layer 360 can be present between the bottom of the channels or valleys and the top surface 331 of (e.g., planar) base member 310. In some embodiments, such as when the microstructured surface is prepared from casting and curing a polymerizable resin composition, the thickness of the land layer is typically at least 0.5, 1, 2, 3, 4, or 5 microns ranging up to 50 microns. In some embodiments, the thickness of the land layer is no greater than 45, 40, 35, 30, 25, 20, 15, or 10 microns.

Referring now to FIG. 5B, an SEM image of the cross-section of a portion of the exemplary device of Example 8 having prism microstructures is provided. The first surface 302 of the microstructured substrate 325 together with the at least one sidewall 340 defines a first open volume 370 that is a total of open space located between the plurality of microstructures 320 from a bottom 336 to a top 327 of each microstructure 320. (For simplicity, the arrow for 370 just points to a portion of the first open volume between two adjacent microstructures 320). The cover 352 together with the top 327 of the first surface 302 of the microstructured substrate 325 and at least one sidewall 340 defines a second open volume 380 located adjacent to the first open volume 370, and taking a total of the combined first open volume and second open volume to be 100% open volume, the first open volume has a larger percent of the 100% open volume than a volume percent of red blood cells that is present in the blood.

In select embodiments, the microstructures comprise an array of peak structures and adjacent valleys, wherein the valleys have a maximum width ranging from 10 microns to 500 microns and the peak structures have an apex angle of greater than 5 degrees and up to 90 degrees.

The orientation of a linear array of peak structures and adjacent valleys extending across a first surface of the microstructured substrate is not particularly limited; they may be oriented at an angle between 0 and 90 degrees with respect to a flow direction of a device. More particularly, the peak structures and adjacent valleys may be oriented at an angle of 0 degrees or more, 5 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, or 75 degrees, or more; and 90 degrees, 85 degrees, 80 degrees, 75 degrees, 70 degrees, 65 degrees, 60 degrees, 55 degrees, 50 degrees, 45 degrees, 40 degrees, 35 degrees, 30 degrees, 25 degrees, 20 degrees, or 15 degrees or less. For instance, in the device 300 of FIG. 5B, the peak structures 320 and valleys 301 are oriented at an angle of 0 degrees with respect to a flow direction of the device 300 (e.g., the same direction as flow). On the microstructured substrate 325 of FIG. 5C, the peak structures 322 and valleys 301 are oriented at an angle of 90 degrees (e.g., perpendicular) with respect to a flow direction (“F”) of a device that would include the microstructured substrate 325. On the microstructured substrate 325 of FIG. 5D, the peak structures 320 and valleys 301 are oriented at an angle of 45 degrees with respect to a flow direction (“F”) of a device that would include the microstructured substrate 325. By selecting an orientation of greater than 0 degrees (and e.g., up to 90 degrees), a particle has a greater chance to come into contact with more than one microstructure in the direction of the flow of fluid into the device, and potentially be more likely to become entrapped within the microstructures.

Further details regarding microstructured substrates having such peak structure arrays and how to form them are described in US 2021/0187819 (Connell et al.), incorporated herein by reference.

### Facet Structure

Similar to a prism structure, FIG. 5E shows an alternative microstructured substrate 700 having a facet structure. More particularly, FIG. 5E illustrates a microstructured substrate 700 defining bottom surfaces 705, top surfaces 720, first sidewalls 732 and facets 733. Stated another way, the microstructures comprise a facet 733 and a side wall 732 meeting the facet 733 at a ridge 720 of the microstructure. The facet 733 and the side wall 732 typically define an oblique angle therebetween.

In select embodiments, the microstructures comprise a facet and a side wall meeting the facet at a ridge of the microstructure and wherein the facet and the side wall define an oblique angle therebetween.

Further details regarding microstructured substrates having such facet structures and how to form them are described in WO 2020/250180 (Kenney et al.), incorporated herein by reference.

### Projection Array Structure

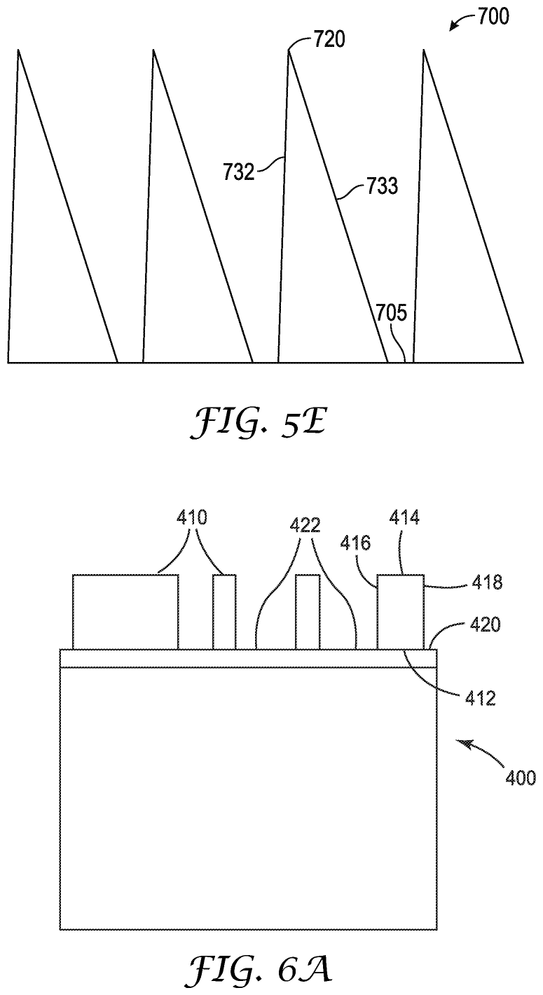

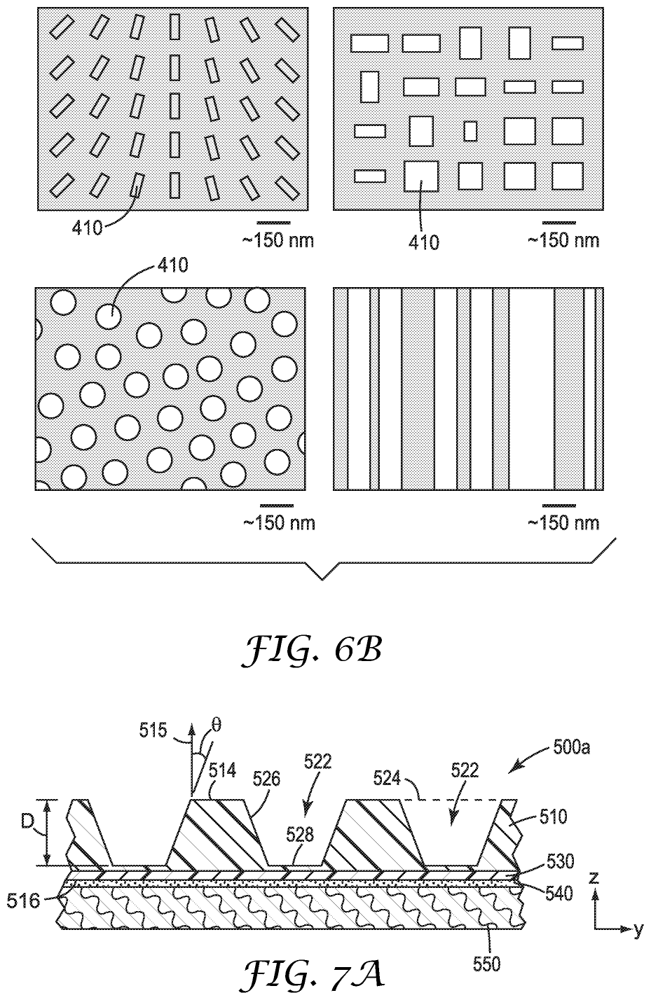

FIG. 6A shows another alternative microstructured substrate 400 having a projection array structure. More particularly, FIG. 6A is a schematic side view of a microstructured substrate 400 that has a two-dimensional (x- and y-axes) array of projections 410 arranged across a first surface 420. Each of the projections 410 comprises a base 412, a top 414, and one or more sides 416, 418 connecting the top to the base. Optionally, each of the projections 410 is a spaced-apart post. For instance, FIG. 6B is a top plan view of four representative engineered micropatterned regions for a two-dimensional array of projections, including spaced-apart posts 410 present in all but the lower right image. Some microstructured surfaces may comprise projections with a range of aspect ratio values, such as an array of projections with constant height and variable width. In such cases, the surface is usually characterized by the largest aspect ratio value.

In select embodiments, the microstructures comprise a two-dimensional (x- & y-axes) array of projections arranged across the first surface of the microstructured substrate, wherein each of the projections comprises a base, a top, and one or more sides connecting the top to the base.

Further details regarding microstructured substrates having such projection arrays and how to form them are described in WO 2020/097319 (Wolk et al.), incorporated herein by reference.

### Cavity Array Structure

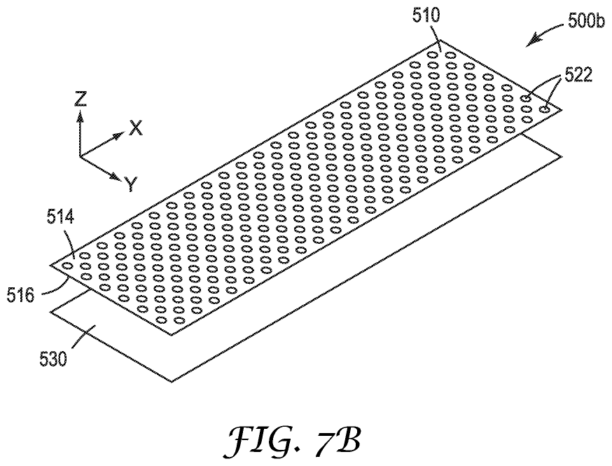

FIG. 7A shows a further alternative microstructured substrate 500a having a cavity array structure. A “cavity array” is an array of cavities having a density of discrete cavities of at least about 100/cm², and preferably at least about 10/mm². The cavities have a three-dimensional structure with dimensions, such as openings with, e.g., diameters in the range of between about 5-250 micrometers, and depths in the range between about 2-250 micrometers. The array can be any regular array such as a close-packed array or a rectangular array, or the cavities can be randomly distributed. More particularly, FIG. 7A is a schematic cross-sectional view of a microstructured substrate 500a having a plurality of cavities 522 extending between a first major surface 514 and a second major surface 516. The microstructured substrate 500a comprises a microstructured layer 510 with first 514 and second 516 major surfaces, in which the microstructures comprise a plurality of cavities 522 extending between the first 514 and second 516 major surfaces. Each cavity comprises a first opening 524, a second opening 528 and at least one side wall 526 extending between the first opening 524 and the second opening 528. Each of the side wall(s) 526 forms a side wall angle θ with a line 515 perpendicular to the first major surface 514 of the microstructured layer 510. Each of the cavities 522 further includes a depth “D” which is the perpendicular distance between first aperture 524 and second aperture 528. Optionally, the microstructured substrate 500a further includes any of an adhesive layer 540, a first substrate 530, or a second substrate layer 550.

FIG. 7B is generalized schematic top perspective exploded view of a microstructured substrate 500b having a plurality of cavities 522 extending between two major surfaces. The microstructured substrate 500b includes a microstructured layer 510 with a first major surface 514 and an opposing second major surface 516. The first major surface 514 includes an array of discrete cavities 522. In one particular embodiment, each of the cavities 522 includes a cross-section parallel to the first major surface 514 that can be circular shaped, oval shaped, or polygon shaped. The cross-section optionally decreases in size in the direction from the first major surface 514 to the second major surface 516. This embodiment of a microstructured substrate 500b further includes a (e.g., flexible) substrate 530 coupled to the second major surface 516 of the microstructured layer 510.

In select embodiments, the microstructured substrate comprises a microstructured layer with first and second major surfaces, wherein the microstructures comprise a plurality of cavities extending between the first and second major surfaces, wherein each cavity comprises a first opening, a second opening and at least one side wall extending between the first opening and the second opening.

Further details regarding microstructured substrates having such cavity arrays and how to form them are described in U.S. Pat. No. 9,329,311 (Halverson et al.), incorporated herein by reference.

### Connected Wells Structure

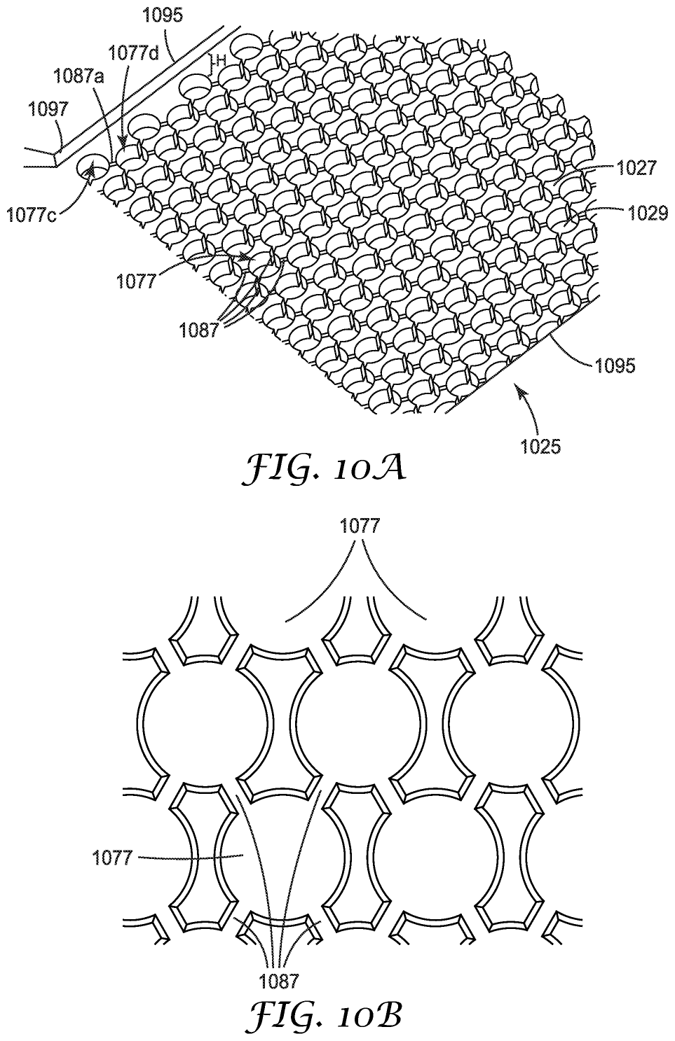

FIGS. 10A-B show a yet further alternative microstructured substrate 1025, wherein the microstructures comprise an array of fluidically connected wells, wherein at least some of the wells are fluidically connected to at least two adjacent wells, each connected via a vent. For instance, FIG. 10A is a schematic perspective view of a portion of a microstructured substrate 1025 having an array of fluidically connected wells 1077 connected to each other by a vent 1087.

FIG. 10B is a schematic top view of a portion of the microstructured substrate 1025 of FIG. 10A, having an array of fluidically connected wells 1077 having circular shapes connected to adjacent wells 1077 by vents 1087. In the particular structure shown in FIGS. 10A-B, the wells 1077 in the center (e.g., have at least one other well located between it and a perimeter of the microstructured substrate) of the microstructured substrate 1025 are each connected to 4 other wells 1077, with each connection being via a vent 1087. There are also wells 1077 located adjacent a perimeter 1095 that are connected to just one or two adjacent wells 1077 via vents 1087. For examples, referring to FIG. 10A, well 1077c is in a corner of the array and is attached to just one other well 1077d via a vent 1087a. Similarly, wells can be attached to three other adjacent wells via vents, four, five, six, seven, eight, nine, ten, eleven, or twelve other adjacent wells via vents.

The shape of the wells is not particularly limited and can include a curvilinear shape, a polygonal shape, an irregular shape, or combinations thereof. In some embodiments, the wells comprise a circular shape, a triangular shape, a quadrilateral shape, an elliptical shape, or combinations thereof. In cases where a well comprises a shape having a corner, a vent is optionally located at the corner (e.g., to decrease the likelihood of trapping an air bubble in the corner).

Typically, each well has an open volume large enough to hold at least one settled particle (e.g., red blood cell), such as 100 femtoliters or greater, 250 femtoliters, 500 femtoliters, 750 femtoliters, 1 picoliter, 100 picoliters, 250 picoliters, 500 picoliters, 750 picoliters, 1 nanoliter, 100 nanoliters, 200 nanoliters, 300 nanoliters, 400 nanoliters, 500 nanoliters, 600 nanoliters, 700 nanoliters, 800 nanoliters, or 900 nanoliters or greater; and 1 microliter or less, 900 nanoliters, 800 nanoliters, 700 nanoliters, 600 nanoliters, 500 nanoliters, 400 nanoliters, 300 nanoliters, 200 nanoliters, 100 nanoliters, 1 nanoliter, 750 picoliters, 500 picoliters, 250 picoliters, 1 picoliter, 750 femtoliters, or 500 femtoliters or less. Stated another way, in some cases each well has an open volume ranging from 100 femtoliters to 1 microliter or 500 femtoliters to 0.1 microliters.

Some typical dimensions for each well include a depth (i.e., a distance between a top surface 1027 of the microstructured substrate 2025 and a bottom surface of a well 1029, as shown in FIG. 10A) of 50 microliters or greater, 75 microliters, 100 microliters, 125 microliters, 150 microliters, 175 microliters, 200 microliters, 225 microliters, 250 microliters, 275 microliters, 300 microliters, 325 microliters, or 350 microliters or greater; and 500 microliters or less, 475 microliters, 450 microliters, 425 microliters, 400 microliters, 375 microliters, 350 microliters, 325 microliters, 300 microliters, 275 microliters, 250 microliters, 225 microliters, 200 microliters, 175 microliters, or 150 microliters or less. This same range of distance is also applicable to a diameter of a well. The diameter is the longest line that passes through a center point of the shape.

Preferably, at least some of the vents between wells are located at a same depth as a bottom surface of the adjacent wells. This assists in urging air bubbles to exit a well instead of getting trapped near the bottom of the well. In some embodiments, a vent has a total depth equal to a total depth of an adjacent well, although this is not a requirement. When a microstructured substrate is formed using a tool, making the vent have the same depth as an adjacent well tends to be more practical than making vents that connect just the lower portions of two wells.

Referring again to FIG. 10A, in some embodiments, the microstructured substrate 1025 further includes at least one sidewall 1097 disposed along a perimeter 1095 of the first surface 1027 of the microstructured substrate 1025. The one or more sidewalls 1087 has a height (“H”) that extends beyond a top surface of the plurality of microstructures by 50 to 250 micrometers

Connected well structures can be made using a multi-photon exposure system as described in U.S. Pat. No. 8,605,256 (DeVoe et al.) to create a patterned tooling. Such structured polymer tools are typically then plated with nickel to create metallized tools. Next, nickel-plated tools are used to make impression molded samples using a press such as a Carver Press (Carver, Wabash, IN) and a resin (e.g., polypropylene resin. Press platens are heated (e.g., to 170° C.), then the tool and resin are pressed together at high force (e.g., 1000 force pounds) for several minutes (e.g., 5-10 minutes). Following cooling (e.g., until the platen temperature reaches 80° C.), pressure is released and molded samples can be removed. Using such a method can provide the microstructured substrate in a form of a microstructured film.

Further details regarding microstructured substrates having such connected wells and how to form them are described in co-owned Application Ser. No. 63/425,473 (Docket No. PA100766US01).

### Stem Web Structure

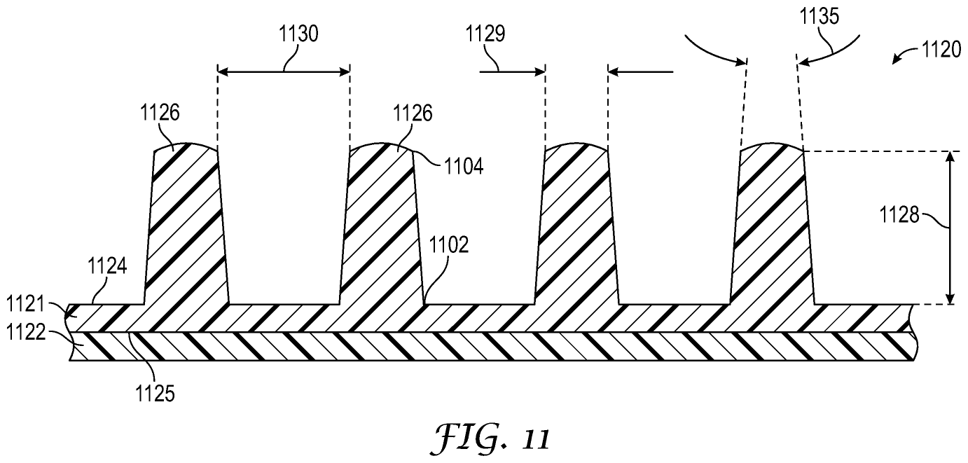

FIG. 11 shows a further alternative microstructured substrate 1120 having a stem web structure. In such embodiments, the microstructures 1126 comprise an array of upstanding stems 1126 extending across the first surface 1124 of the microstructured substrate 1120. The microstructures 1126 are generally upstanding stems of a variety of shapes. By “generally upstanding” it is meant that the stems protrude (e.g., in a planar direction) away from the first surface 1124. The stems 1126 may protrude upward from the surface 1124 at generally normal angles, or the stems 1126 may protrude at angles away from the surface 1124. The stems may also be of an irregular shape such that they may not protrude at any one uniform angle.

The microstructured substrate 1120 includes a backing layer 1121 having a first surface 1124 with an array of generally upstanding stems 1126. The stems 1126 may be arranged in a regular or an irregular array. Various patterns of stems may be used, such as hexagonal, diagonal, sinusoidal, etc. The stems 1126 may be constructed at least in part of an elastomeric material. In some cases, the entire exterior surface of the stems 1126 are an elastomeric material. In the embodiment of FIG. 11, the backing layer 1121 is integrally formed with the stems 1126. The combination of the backing layer 1121 and the stems 1126 is sometimes referred to as a stem web. Although the illustrated embodiments show the stems 1126 as being generally cylindrical, the sides of the stems 1126 typically have a slight taper 1135 to facilitate removal from a mold. As shown, the taper 1135 is inward from the base 1102 to the tip 1104 of the stem 1126. It is expressly contemplated that the stem may be constructed having a taper outward from the base to the tip of the stem. A variety of non-cylindrical shapes can also be utilized, such as truncated cones or pyramids, rectangles, hemispheres, squares, hexagon, octagon, gum drops, and the like.

The backing layer 1121, from which the stems 1126 directly extend, is typically about 0.05 millimeters to about 0.5 millimeters (0.002 inches to 0.02 inches) thick. Therefore, additional backing layer(s) 1122 are optionally applied to the second surface 1125 to reinforce the backing layer 1121 and form a multilayer base or backing construction. As used herein, “backing” or “base” layer will be used to refer to the collective backing or base construction. Such a construction may be single or multi-layered (such as shown in FIG. 1) having one or more layers that support the generally upstanding stems 1126, although typically at most one of these layers 1121 will be integrally formed with the stems 1126.

The stems typically have a height 1128 in the range of about 0.2 mm to about 3 mm, preferably about 0.2 mm to about 1.5 mm. The separation or gap 1130 between adjacent stems 1126 is generally in the range of about 0.25 mm and about 2.5 mm and more typically in the range of about 0.4 mm to about 1.0 mm. This separation gap creates a percent of free volume that is a volume within the stem web that is not occupied by the stems. The percent of free volume is typically from 60 to 98% of the stem web and more typically from 85 to 95%. The stems 1126 have a maximum cross sectional dimension 1129 of about 0.076 mm to about 0.76 mm. The stems 1126 are arranged on the backing in a density of at least 15.5 per centimeter squared (100 per square inch), and more typically at least 50 per centimeter squared. The stem density is generally at most about 1500 per centimeter squared, more typically at most about 500 per centimeter squared. The stems have an aspect ratio of at least 1.25, and preferably at least 1.5, and most preferably at least 2.0. Aspect ratio refers to the ratio of stem height to the maximum cross sectional dimension. For stems with a circular cross section, the maximum cross sectional dimension is the stem diameter.

Suitable elastomeric stem materials include classes of elastomers such as anionic triblock copolymers, polyolefin-based thermoplastic elastomers, thermoplastic elastomers based on halogen-containing polyolefins, thermoplastic elastomers based on dynamically vulcanized elastomer-thermoplastic blends, thermoplastic polyether ester or polyester based elastomers, thermoplastic elastomers based on polyamides or polyimides, ionomeric thermoplastic elastomers, hydrogenated block copolymers in thermoplastic elastomer interpenetrating polymer networks, thermoplastic elastomers by carbocationic polymerization, polymer blends containing styrene/hydrogenated butadiene block copolymers, and polyacrylate-based thermoplastic elastomers. Some specific examples of elastomers are natural rubber, butyl rubber, EPDM rubber, silicone rubber such as polydimethyl siloxane, polyisoprene, polybutadiene, polyurethane, ethylene/propylene/diene terpolymer elastomers, chloroprene rubber, styrene-butadiene copolymers (random or block), styrene-isoprene copolymers (random or block), acrylonitrile-butadiene copolymers, mixtures thereof and copolymers thereof. The block copolymers may be linear, radial or star configurations and may be diblock (AB) or triblock (ABA) copolymers or mixtures thereof. Blends of these elastomers with each other or with modifying non-elastomers are also contemplated. Commercially available elastomers include block polymers (e.g., polystyrene materials with elastomeric segments), available from KRATON Polymers Company of Houston, Texas, under the designation KRATON™.

The elastomeric resin materials, such as those described above, may also have added to them any of a number of customary additives, including, for example, plasticizers, tackifiers, fillers, antioxidants, UV absorbers, hindered amine light stabilizers (HALS), dyes or pigments, opacifying agents and the like.

Suitable backing layer materials include thermoplastic polyurethanes, polyvinyl chlorides, polyamides, polyimides, polyolefins (e.g., polyethylene and polypropylene), polyesters (e.g., polyethylene terephthalate), polystyrenes, nylons, acetals, block polymers (e.g., polystyrene materials with elastomeric segments, available from KRATON Polymers Company of Houston, Texas, under the designation KRATON™, polycarbonates, thermoplastic elastomers (e.g., polyolefin, polyester or nylon types) and copolymers and blends thereof. In some cases, the entire stem web is formed of one or more thermoplastic materials, such as those listed above. The thermoplastic material may also contain additives, including but not limited to fillers, fibers, antistatic agents, lubricants, wetting agents, foaming agents, surfactants, pigments, dyes, coupling agents, plasticizers, suspending agents, hydrophilic/hydrophobic additives, adhesives, and the like.

Further details regarding microstructured substrates having such stem webs and how to form them are described in WO 2009/020811 (Tuman et al), incorporated herein by reference.

In a third aspect, the present disclosure provides a method of separating solid particles from a fluid. The method comprises:
a) obtaining a device comprising:
   1) a microstructured substrate comprising a plurality of microstructures extending across a first surface of the microstructured substrate, wherein at least a portion of an exterior surface of the plurality of microstructures are configured to allow capillary action;
   2) a cover disposed a selected distance apart from a top of the first surface of the microstructured substrate;
   3) at least one sidewall that attaches the cover to the first surface of the microstructured substrate along a perimeter of the first surface of the microstructured substrate;
   4) a first aperture defined by at least one of the microstructured substrate or the cover; and
   5) a second aperture defined by at least one of the microstructured substrate or the cover;
      wherein the first surface of the microstructured substrate together with the at least one sidewall defines a first open volume that is a total of open space located between the plurality of microstructures from a bottom to a top of each microstructure, wherein the cover together with the top of the first surface of the microstructured substrate and the at least one sidewall defines a second open volume located adjacent to the first open volume, and taking a total of the combined first open volume and second open volume to be 100% open volume, the first open volume has a larger percent of the 100% open volume than a volume percent of particles that is present in the fluid.
b) filling the device with a volume of the fluid through the first aperture via capillary action;
c) waiting for a time sufficient for at least a portion of the particles to settle within the first open volume of the plurality of microstructures; and
d) applying pressure to the device, thereby causing at least 10% of the fluid, from which at least some of the particles have been retained within the first open volume of the plurality of microstructures, to flow out of the device through either the first aperture or the second aperture.

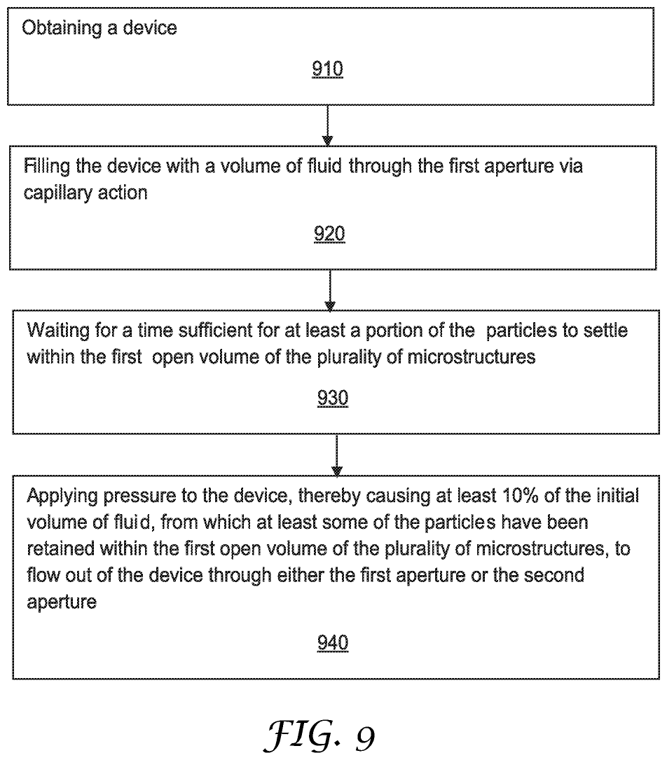

Referring to FIG. 9, the method comprises obtaining a device 910 (wherein the device is as described directly above); filling the device with a volume of fluid through the first aperture via capillary action 920; waiting for a time sufficient for at least a portion of the particles to settle within the first open volume of the plurality of microstructures 930; and applying pressure to the device, thereby causing at least 10% of the initial volume of fluid, from which at least some of the particles have been retained within the first open volume of the plurality of microstructures, to flow out of the device through either the first aperture or the second aperture 940. The characteristics, materials, structures, etc., of the device for the method of the third aspect may be according to any embodiment of the device as described in detail above with respect to the first and second aspects. Similarly, the method of the third aspect may be according to any of the embodiments of the method of the first aspect described above in detail.

### EXEMPLARY EMBODIMENTS

In a first embodiment, the present disclosure provides a method of separating red blood cells from blood. The method includes obtaining a device including a microstructured substrate comprising a plurality of microstructures extending across a first surface of the microstructured substrate, wherein at least a portion of an exterior surface of the plurality of microstructures are configured to allow capillary action; a cover disposed a selected distance apart from a top of the first surface of the microstructured substrate; at least one sidewall that attaches the cover to the first surface of the microstructured substrate along a perimeter of the first surface of the microstructured substrate; a first aperture defined by at least one of the microstructured substrate or the cover; and a second aperture defined by at least one of the microstructured substrate or the cover. The first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume, and taking a total of the combined first open volume and second open volume to be 100% open volume, the first open volume has a larger percent of the 100% open volume than a volume percent of red blood cells that is present in the blood. The method further includes filling the device with a volume of blood through the first aperture via capillary action and waiting for a time sufficient for at least a portion of the red blood cells to settle within the first open volume of the plurality of microstructures. Additionally, the method includes applying pressure to the device, thereby causing at least 10% of the initial volume of blood, from which at least some of the red blood cells have been retained within the first open volume of the plurality of microstructures, to flow out of the device through either the first aperture or the second aperture.

In a second embodiment, the present disclosure provides a method according to the first embodiment, wherein the at least one sidewall is a portion of the microstructured substrate.

In a third embodiment, the present disclosure provides a method according to the first embodiment or the second embodiment, wherein at least 15%, at least 20%, or at least 30% of the blood is caused to flow out of the device upon the application of pressure.

In a fourth embodiment, the present disclosure provides a method according to any of the first through third embodiments, wherein the time is sufficient for at least 20%, 30%, 40%, 50%, 60%, 70%, 80%, or at least 90% of the red blood cells to settle within the first open volume of the plurality of microstructures.

In a fifth embodiment, the present disclosure provides a method according to any of the first through fourth embodiments, wherein the microstructured substrate is a microstructured film.

In a sixth embodiment, the present disclosure provides a method according to any of the first through fifth embodiments, wherein at least a portion of the exterior surface of the plurality of microstructures comprises a surfactant, a surface treatment, a hydrophilic polymer, a flocculant, or any combination thereof.

In a seventh embodiment, the present disclosure provides a method according to any of the first through sixth embodiments, wherein the flocculant is hydrophilic and non-hemolytic.

In an eighth embodiment, the present disclosure provides a method according to the sixth embodiment or the seventh embodiment, wherein the flocculant comprises a modified or unmodified aminopolymer selected from the group consisting of polyethylenimine, polylysine, polyaminoamides, polyallylamine, polyvinylamine, polydimethylamine-epichlorohydrin-ethylenediamine, polydiallyldimethylammonium chloride, cationic polyacrylamide (CPAM), polyaminosiloxanes, and dendrimers formed from polyamindoamine (PAMAM) and polypropylenimine.

In a ninth embodiment, the present disclosure provides a method according to any of the sixth through eighth embodiments, wherein the flocculant comprises a modified or unmodified polyethylenimine polymer.

In a tenth embodiment, the present disclosure provides a method according to any of the sixth through ninth embodiments, wherein at least a portion of the flocculant dissolves, disperses, or a combination thereof into the blood following the filling of the device with the volume of blood.

In an eleventh embodiment, the present disclosure provides a method according to the tenth embodiment, wherein the flocculant is present in the volume of blood in an amount of 0.01 to 5000 micrograms per milliliter of blood.

In a twelfth embodiment, the present disclosure provides a method according to any of the first through eleventh embodiments, wherein the pressure is positive pressure.

In a thirteenth embodiment, the present disclosure provides a method according to any of the first through twelfth embodiments, wherein the pressure is negative pressure.

In a fourteenth embodiment, the present disclosure provides a method according to any of the first through thirteenth embodiments, wherein the first aperture is defined by the cover.

In a fifteenth embodiment, the present disclosure provides a method according to any of the first through fourteenth embodiments, wherein the second aperture is defined by the microstructured substrate or the cover.

In a sixteenth embodiment, the present disclosure provides a method according to any of the first through fifteenth embodiments, wherein the blood is undiluted.

In a seventeenth embodiment, the present disclosure provides a method according to any of the first through sixteenth embodiments, wherein the red blood cells settle solely due to gravity.

In an eighteenth embodiment, the present disclosure provides a method according any of the first through seventeenth embodiments, wherein the device further comprises an adhesive layer disposed between the cover and the microstructured substrate.

In a nineteenth embodiment, the present disclosure provides a method according to any of the first through eighteenth embodiments, wherein the microstructures comprise a plurality of ribs alternated with channels extending across the first surface of the microstructured substrate and wherein each of the ribs comprises side walls and a top surface and each of the channels comprises a bottom surface.

In a twentieth embodiment, the present disclosure provides a method according to the nineteenth embodiment, wherein the top surface of each rib is the top of a cap disposed on the side walls and the cap has a width greater than a width between opposing side walls.

In a twenty-first embodiment, the present disclosure provides a method according to any of the first through eighteenth embodiments, wherein the microstructures comprise an array of peak structures and adjacent valleys, wherein the valleys have a maximum width ranging from 10 microns to 500 microns and the peak structures have an apex angle of greater than 5 degrees and up to 90 degrees.

In a twenty-second embodiment, the present disclosure provides a method according to the twenty-first embodiment, wherein the array of peak structures and adjacent valleys extending across a first surface of the microstructured substrate is oriented at an angle between 0 and 90 degrees with respect to a flow direction of the device.

In a twenty-third embodiment, the present disclosure provides a method according to the twenty-first embodiment or the twenty-second embodiment, further comprising gaps in between adjacent peak structures.

In a twenty-fourth embodiment, the present disclosure provides a method according to any of the first through eighteenth embodiments wherein the microstructures comprise a two-dimensional (x- & y-axes) array of projections arranged across the first surface of the microstructured substrate; wherein each of the projections comprises a base, a top, and one or more sides connecting the top to the base.

In a twenty-fifth embodiment, the present disclosure provides a method according to any of the first through eighteenth embodiments, wherein the microstructured substrate comprises a microstructured layer with first and second major surfaces, wherein the microstructures comprise a plurality of cavities extending between the first and second major surfaces; wherein each cavity comprises a first opening, a second opening and at least one side wall extending between the first opening and the second opening.

In a twenty-sixth embodiment, the present disclosure provides a method according to any of the first through thirteenth embodiments, wherein the microstructures comprise a facet and a side wall meeting the facet at a ridge of the microstructure and wherein the facet and the side wall define an oblique angle therebetween.

In a twenty-seventh embodiment, the present disclosure provides a method according to any of the first through eighteenth embodiments, wherein the microstructures comprise an array of fluidically connected wells, wherein at least some of the wells are fluidically connected to at least two adjacent wells, each connected via a vent.

In a twenty-eighth embodiment, the present disclosure provides a method according to any of the first through eighteenth embodiments, wherein the microstructures comprise an array of upstanding stems extending across the first surface of the microstructured substrate.

In a twenty-ninth embodiment, the present disclosure provides a method according to any of the first through twenty-eighth embodiments, wherein the volume of the blood filled through the first aperture is up to 100 microliters of the blood.

In a thirtieth embodiment, the present disclosure provides a method according to any of the first through twenty-ninth embodiments, wherein a ratio of the first open volume to the second open volume is greater than 1:1.

In a thirty-first embodiment, the present disclosure provides a method according to any of the first through thirtieth embodiments, further comprising passing the blood through a filter before entering the device, passing the blood from which at least some of the red blood cells were retained within the first open volume of the plurality of microstructures after exiting the device, or both.

In a thirty-second embodiment, the present disclosure provides a method according to any of the first through thirty-first embodiments, further comprising adding a flocculant to the volume of blood before filling the device with the volume of blood.

In a thirty-third embodiment, the present disclosure provides a method according to the thirty-second embodiment, wherein the flocculant is added and is present in an amount of 0.01 to 5000 micrograms/mL of blood.

In a thirty-fourth embodiment, the present disclosure provides a device. The device includes a microstructured substrate comprising a plurality of microstructures extending across a first surface of the microstructured substrate. The microstructures cover at least 90% of the first surface of the microstructured substrate and at least a portion of an exterior surface of the plurality of microstructures are configured to allow capillary action. The device also includes a cover disposed a selected distance apart from a top of the first surface of the microstructured substrate and at least one sidewall that attaches the cover to the first surface of the microstructured substrate along a perimeter of the first surface of the microstructured substrate. Further, the device includes a first aperture defined by at least one of the microstructured substrate or the cover and a second aperture defined by at least one of the microstructured substrate or the cover. The first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume.

In a thirty-fifth embodiment, the present disclosure provides a method of separating solid particles from a fluid. The method includes obtaining a device including a microstructured substrate comprising a plurality of microstructures extending across a first surface of the microstructured substrate. At least a portion of an exterior surface of the plurality of microstructures are configured to allow capillary action. The device also includes a cover disposed a selected distance apart from a top of the first surface of the microstructured substrate and at least one sidewall that attaches the cover to the first surface of the microstructured substrate along a perimeter of the first surface of the microstructured substrate. Further, the device includes a first aperture defined by at least one of the microstructured substrate or the cover and a second aperture defined by at least one of the microstructured substrate or the cover. The first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume. Taking a total of the combined first open volume and second open volume to be 100% open volume, the first open volume has a larger percent of the 100% open volume than a volume percent of particles that is present in the fluid. The method further includes filling the device with a volume of the fluid through the first aperture via capillary action and waiting for a time sufficient for at least a portion of the particles to settle within the first open volume of the plurality of microstructures. Additionally, the method includes applying pressure to the device, thereby causing at least 100 of the fluid, from which at least some of the particles have been retained within the first open volume of the plurality of microstructures, to flow out of the device through either the first aperture or the second aperture.

### EXAMPLES

Objects and advantages of this disclosure are further illustrated by the following examples, but the particular materials and amounts thereof recited in these examples, as well as other conditions and details, should not be construed to unduly limit this disclosure. Unless otherwise noted or otherwise apparent from the context, all parts, percentages, ratios, etc. in the Examples and the rest of the specification are by weight. A materials table (below) lists materials used in the examples and their sources.

### Materials

| Description | Source |
|---|---|
| GIBCO 1X Phosphate Buffered Saline (PBS), | Thermo Fisher Scientific, Waltham, MA |
| pH 7.4 | |
| PHOTOMER 6210 Aliphatic urethane | IGM Resins, Charlotte, NC |
| diacrylate oligomer | |
| 1,6-Hexanediol diacrylate (SR238) | Sartomer, Exton, PA |
| LUCIRIN TPO Photoinitiator | BASF Corporation, Florham Park, NJ |
| DAROCUR 1173 Photoinitiator | BASF Corporation, Florham Park, NJ |
| PHOTOMER 6010 Aliphatic urethane acrylate | IGM Resins, Charlotte, NC |
| oligomer | |
| Ethoxylated (10) bisphenol A diacrylate | Sartomer, Exton, PA |
| (SR602) | |
| Ethoxylated (4) bisphenol A diacrylate | Sartomer, Exton, PA |
| (SR601) | |
| Trimethylolpropane triacrylate (TMPTA) | Cytec Industries, Woodland Park, NJ |
| Phenoxyethyl Acrylate (PEA) | Eternal Chemical Co. Ltd., Kaohsiung, Taiwan |
| IRGANOX 1035 antioxidant (I1035) | BASF Corporation, Florham Park, NJ |
| IPEGAL-CO630 anionic surfactant | Sigma-Aldrich, St. Louis, MO |
| C700-35N Polypropylene Copolymer Resin | Braskem, Philadelphia, PA |
| 3M SCOTCH-WELD Epoxy Adhesive DP100 | 3M Company, St. Paul, MN |
| Plus Clear | |
| O-methylisourea hemisulfate | Alfa Aesar, Ward Hill, PA |

### Preparatory Examples 1-4. Procedure for Preparing Prism Structure Microstructured Films

A UV curable resin was prepared from PHOTOMER 6210 aliphatic urethane diacrylate oligomer (75 parts), SR238 1,6-hexanediol diacrylate (25 parts), and LUCIRIN TPO photoinitiator (0.5%). The components were blended in a high speed mixer, heated in an oven at about 70° C. for 24 hours, and then cooled to room temperature. Copper buttons were used as templates for preparing linear prism films. A button and the compounded resin were both heated in an oven at about 70° C. for 15 minutes. Warmed resin was applied using a transfer pipette to the center of the warmed button. A section of MELINEX 618 PET support film (DuPont Teijin Films, Chester, VA) was placed over the applied resin followed by a glass plate. The primed surface of the PET film was oriented to contact the resin. The glass plate was held in place with hand pressure until the resin completely covered the surface of the button. The glass plate was carefully removed. If any air bubbles were introduced, a rubber hand roller was used to remove them.

The sample was cured with UV light by passing the sample 2 times through a UV processor (model QC 120233AN with two Hg vapor lamps, obtained from RPC Industries, Plainfield, IL) at a rate of 15.2 meters/minute under a nitrogen atmosphere. The cured, microstructured film having an array pattern as shown in FIG. 5A was removed from the copper template by gently pulling away at a 90° angle. A release liner backed adhesive layer (8 mil thick, obtained as 3M 8188 Optically Clear Adhesive from the 3M Corporation) was optionally applied to the back surface (i.e., non-microstructured surface) of the microstructured film using a hand roller. The features of the linear prism microstructured films that were prepared are reported in Table 1 as Preparatory Examples 1-4.

The microstructured films were cut into 2.54 cm by 7.62 cm sections and a surfactant coating was applied by dipping each section into a 0.1 weight percent aqueous solution of IPEGAL-CO630 anionic surfactant and then immediately removing the film from the solution. The resulting surfactant coated microstructured film sections were air dried at ambient temperature and humidity.

TABLE 1

| | | | Apex | |
|---|---|---|---|---|
| Microstructured | Peak Height | Pitch | Angle | Apex |
| Film | (micrometers) | (micrometers) | (degrees) | Shape |
| Preparatory | 50 | 27 | 30 | Sharp |
| Example 1 | | | | |
| Preparatory | 50 | 58 | 60 | Sharp |
| Example 2 | | | | |
| Preparatory | 50 | 100 | 90 | Sharp |
| Example 3 | | | | |
| Preparatory | 50 | 173 | 120 | Sharp |
| Example 4 | | | | |

### Preparatory Example 5. Procedure for Preparing Louver Structure Microstructured Films

A diamond (220 micrometers deep) was used to cut a tool having a plurality of parallel linear grooves. The grooves were spaced apart by a pitch of 60 micrometers. Resin A was prepared by mixing the materials in Table 2 below.

TABLE 2
Composition of Resin A used to Prepare the Microstructured
Film of Preparatory Example 5

| | Parts by |
|---|---|
| Material | Weight |
| PHOTOMER 6010 Aliphatic urethane acrylate oligomer | 60 |
| Ethoxylated (10) bisphenol A diacrylate (SR602) | 20 |
| Ethoxylated (4) bisphenol A diacrylate (SR601) | 4 |
| Trimethylolpropane triacrylate (TMPTA) | 8 |
| Phenoxyethyl Acrylate (PEA) | 8 |
| DAROCUR 1173 Photoinitiator | 0.35 |
| LUCIRIN TPO Photoinitiator | 0.10 |
| IRGANOX 1035 antioxidant (I1035) | 0.20 |

A cast-and-cure microreplication process was carried out with Resin A and the tool described above. The line conditions were resin temperature 150° F. (65.6° C.), die temperature 150° F. (65.6° C.), coater IR 120° F. (48.9° C.) edges/130° F. (54.4° C.) center, tool temperature 100° F. (37.8° C.), and line speed 70 feet per minute (fpm) (0.36 meters per second (m/s)). Fusion D lamps (obtained from Fusion UV Systems, Gaithersburg, MD), with peak wavelength at 385 nm, were used for curing and operated at 100% power. The resulting “louver” microstructured film comprised a plurality of protrusions (ribs) separated by channels as illustrated in FIG. 4A (described in detail above). The microstructured film was a topographical inverse of the tool such that the protrusions of the microstructured film were a negative replication of the grooves of the tool and the channels of the microstructured film were negative replication of the uncut portions of the tool between the grooves. The protrusions (ribs) of the microstructured film were evenly spaced with a height (“H”) of 220 micrometers, width (“W”) of 30 micrometers, pitch (“P”) of 60 micrometers, and wall angle θ of 91.5 degrees [resulting in the protrusions being slightly tapered (i.e., wider at the bottom surface and narrower at the top surface)]. The land layer (“L”) of the cured resin had a thickness of 8 micrometers. The base layer was a PET film (3M Company, St. Paul, MN) having a thickness of 74.4 micrometers. The side of the PET film that contacted the resin was primed with a thermoset acrylic polymer (RHOPLEX 3208 polymer obtained from Dow Chemical, Midland, MI).

The microstructured film was cut into 2.54 cm by 7.62 cm sections and a surfactant coating was applied by dipping each section into a 0.1 weight percent aqueous solution of IPEGAL-CO630 anionic surfactant and then immediately removing the film from the solution. The resulting surfactant coated microstructured film sections were air dried at ambient temperature and humidity.

### Example 1. Device Preparation

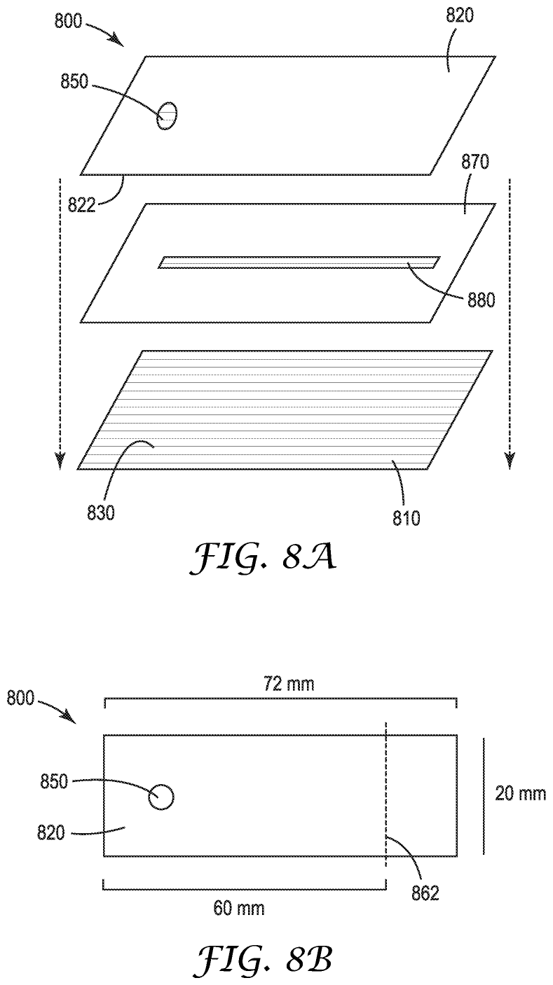

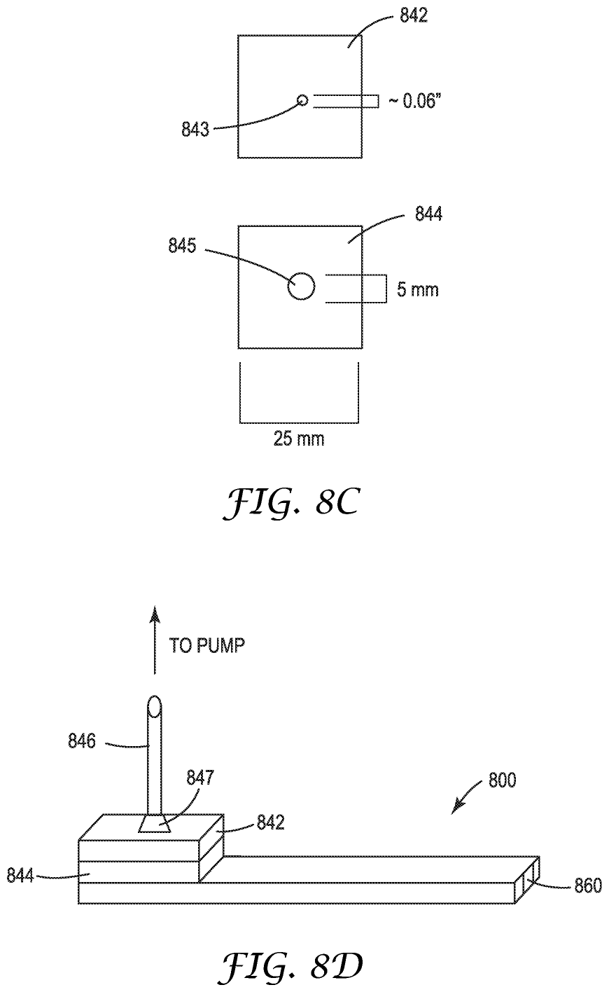

Devices 800 (shown in FIGS. 8A and 8B) were prepared by forming a laminate of three film sections. A cover sheet component (i.e., cover 820) of the device 800 was prepared by laser cutting a 72 mm long by 20 mm wide section from a sheet of 3M Microfluidic Diagnostic Film 9962 (a polyester film (3.9 mil) with a hydrophilic coating on both sides, including a major surface 822 of the cover 820 that faced the microstructured substrate 830, obtained from the 3M Company). A circular hole (5 mm diameter) was laser cut into the film such that the center of the hole was positioned 13.5 mm in a perpendicular direction from the narrow edge of the film and 10 mm in a perpendicular direction from the long edge of the film. The circular hole formed the first aperture 850 of the device 800. The second film component (i.e., adhesive layer 870) of the device was prepared by laser cutting a 72 mm long by 20 mm wide section from a sheet of 3M 1522 Double-Sided Medical Tape (a clear, double sided acrylic adhesive with a polyethylene backing, obtained from the 3M Company). The overall thickness of the double-sided tape with release liners removed was measured to be 150 micrometers using a digital caliper. A rectangular opening 880 (60 mm long by 2.5 mm wide) was laser cut into the second film component and oriented such that the narrow edges of the opening were positioned 11 mm from the narrow edges of the film and the long edges of the opening were positioned 8.75 mm from the long edges of the film.

The third film component of the device (i.e., microstructured substrate 810) was a 72 mm long by 20 mm wide laser cut section of the surfactant coated microstructured film of Preparatory Example 1. All of the laser cuts in films were done using a Muse Core CO₂ Laser Cutter (Full Spectrum Laser, Las Vegas, Nevada).

The device 800 was constructed by removing any release liners from the films and then edge aligning the films into a stack with the second film sandwiched between the cover sheet film and the microstructured film. The films were oriented so that the microstructured surface 830 of the third film faced the second film and the major surface 822 of the cover. Adhesive lamination of the stack was completed by applying a 4 pound (1.8 kilogram) roller to the stack with one back-and-forth motion of the roller. The second adhesive film formed a fluid seal between the cover sheet and top surface of the microstructured film around the edges of the rectangular opening and first aperture hole (e.g., forming a sidewall). In the final step, a razor blade was used to trim the stack (dashed line 862 of FIG. 8B) at the edge located distal from the first aperture so that the resulting device had overall dimensions of 60 mm long by 20 mm wide. This cut through the opening in the second film exposed the second aperture of the device as a 2.5 mm rectangular opening in the newly created edge of the device 800.

### Example 2

Devices were prepared according to the same procedure as reported in Example 1 with the exception that the second film component of the device was prepared using 3M 1513 Double-Sided Medical Tape (a clear, double sided acrylic adhesive with a polyester backing, obtained from the 3M Company). The overall thickness of the double-sided tape with release liners removed was measured to be 75 micrometers using a digital caliper.

### Example 3

Devices were prepared according to the same procedure as reported in Example 1 with the exception that the third film component of the device was prepared using the surfactant coated microstructured film of Preparatory Example 2.

### Example 4

Devices were prepared according to the same procedure as reported in Example 1 with the exception that the third film component of the device was prepared using the surfactant coated microstructured film of Preparatory Example 3.

### Comparative Example A

Devices were prepared according to the same procedure as reported in Example 1 with the exception that the third film component of the device was prepared using the surfactant coated microstructured film of Preparatory Example 4.

### Example 5

Devices were prepared according to the same procedure as reported in Example 1 with the exception that the third film component of the device was prepared using the surfactant coated microstructured film of Preparatory Example 5.

### Example 6

Devices were prepared according to the same procedure as reported in Example 1 with the exception that the third film component of the device was prepared using the surfactant coated microstructured film of Preparatory Example 5 and the second film component of the device was prepared using 3M 1513 Double-Sided Medical Tape.

TABLE 3
Summary of Device Features and Dimensions

| | | | | Distance from Cover |
|---|---|---|---|---|
| | | | Apex Angle | Sheet to Top Surfaces |
| | | Microstructure | (degrees) | of Microstructured |
| | Microstructured | Feature Height | (for prismatic | Features |
| Device | Film Type | (micrometers) | films) | (micrometers) |
| Example 1 | Prism | 50 | 30 | 150 |
| Example 2 | Prism | 50 | 30 | 75 |
| Example 3 | Prism | 50 | 60 | 150 |
| Example 4 | Prism | 50 | 90 | 150 |
| Comparative | Prism | 50 | 120 | 150 |
| Example A | | | | |
| Example 5 | Louver | 220 | Not applicable | 150 |
| Example 6 | Louver | 220 | Not Applicable | 75 |

### Comparative Example B

Devices were prepared according to the same procedure as reported in Example 1 with the exception that the third film component of the device was prepared using a non-microstructured polyethylene terephthalate (PET) film (MELINEX 454 film (3 mil), Dupont Teijin Films) as the third film component of the device.

### Comparative Example C

Devices were prepared according to the same procedure as reported in Example 1 with the exception that the third film component of the device was prepared using the non-microstructured film of Comparative Example B (MELANEX 454 PET film) as the third film component and the second film component of the device was prepared using 3M 1513 Double-Sided Medical Tape.

### Example 7. Method of Separating Red Blood Cells from Blood

Defibrinated sheep blood (obtained from Becton Dickinson, Franklin Lakes, NJ) was measured to have an undiluted hematocrit concentration of 40% using a Zip-IQ PCV Centrifuge (LW Scientific Incorporated, Lawrenceville, GA). In addition to the undiluted blood sample, diluted blood samples of 12%, 8%, and 4% hematocrit were prepared using 1× phosphate buffered saline (PBS).

A module for delivering blood samples to devices 800 was prepared (shown in FIGS. 8C and 8D). Module components included a silicone gasket 844 (25 mm×25 mm×3.2 mm) prepared from SYLGARD 184 silicone elastomer, Dow Chemical, Midland, MI) with a 5 mm hole cut in the center of the gasket and a sheet 842 (25 mm×25 mm×3.2 mm) of PLEXIGLAS polymethyl methacrylate (PMMA) film (Röhm GmbH, Darmstadt, Germany) that had a 0.06 inch (1.52 mm) diameter hole drilled in the center of the sheet. A section of ethyl vinyl acetate (EVA) plastic tubing 846 [0.02 inch (0.51 mm) inner-diameter and 0.06 inch (1.52 mm) outer-diameter, McMaster-Carr, Elmhurst, IL] was inserted in the hole of the PLEXIGLAS film sheet and secured in place with HARDMAN DOUBLE/BUBBLE epoxy (Royal Adhesives, Wilmington, CA) 847. The opposite end of the tubing was fit over a 22.5 gauge needle that was attached to a 1 mL Luer-Lok Syringe.

A device 800 (selected from the devices of Examples 1-6 and Comparative Examples A-C) was placed on a horizontal surface. A sample of blood (20-50 microliters) was added to the first aperture of a device and the blood was allowed to wick to the end of the device by capillary flow. Next, the silicone gasket 844 was placed on the cover sheet of a device and aligned so that the hole in the gasket was centered over the first aperture of the device. The PLEXIGLAS sheet 842 (having the EVA plastic tubing 846 adhered to it as described above) was then placed on the exposed surface of the gasket and aligned so that the hole in the sheet was centered over the hole in the gasket, forming the assembly of FIG. 8D. The syringe (not shown) attached to the other end of the EVA plastic tubing was placed in a syringe pump (model NE-1600, New Era Pump Systems Inc, Farmingdale, NY) (not shown). The pump was activated with the flow set to 100 microliters/minute. The blood sample flowing out of the device from the second aperture 860 was collected. A 10 microliter sample of the collected blood was diluted using 90 microliters of 1×PBS. The diluted sample was pipetted into a C-CHIP Disposable Hemacytometer according to the manufacturer's instructions (Incyto, Republic of Korea). For comparison, a sample of the blood that was added to the device was also pipetted into a C-CHIP Disposable Hemacytometer. The counting slides were analyzed using a Zeiss LSM 510 META module Axioplan 2 upright confocal microscope (Zeiss, Jena, Germany). Red blood cells were counted manually or by using Image J image processing software (National Institutes of Health, Bethesda, MD). The percent red blood cell (RBC) reduction of a blood sample using the described method was calculated by comparing the RBC count of the blood sample collected from the device to the RBC count of the blood sample added to the device according to Equation 1. Each device was tested with a specified blood sample in triplicate (n=3 devices) and the results in % RBC reduction are reported in Table 4 as the mean value.

$$( 1 - \frac{\begin{matrix}RBC count of blood \\ sample collected from the Device\end{matrix}}{RBC count of blood sample added to the Device} ) \times 100 = \% RBC reduction \qquad Equation 1$$

TABLE 4

| | Percent Hematocrit of | |
|---|---|---|
| | Blood Sample Added | Percent RBC |
| Device | to Device | Reduction |
| Example 1 | 4% | 83% |
| Example 1 | 8% | 47% |
| Example 1 | 12% | 14% |
| Example 2 | 4% | 80% |
| Example 2 | 8% | 57% |
| Example 2 | 12% | 0% |
| Example 3 | 4% | 66% |
| Example 4 | 4% | 26% |
| Comparative | 4% | −6% |
| Example A | | |
| Example 5 | 4% | 82% |
| Example 5 | 8% | 61% |
| Example 5 | 12% | 41% |
| Example 5 | 40% | 29% |
| Example 6 | 40% | 53% |
| Comparative | 4% | 9% |
| Example B | | |
| Comparative | 8% | −27% |
| Example B | | |
| Comparative | 12% | 9% |
| Example B | | |
| Comparative | 4% | 6% |
| Example C | | |
| Comparative | 8% | 6% |
| Example C | | |
| Comparative | 12% | −13% |
| Example C | | |

### Example 8

A CAD design file was used to fabricate a masterform for the microstructured substrate of FIG. 2B of a device using a multi-photon exposure system described in U.S. Pat. No. 8,605,256 (DeVoe et al.) and U.S. Pat. No. 8,455,846 (Gates et al.). A negative contrast photoresist, such as described in U.S. Pat. No. 10,133,174 (Lee et al.), was photo-patterned on a silicon wafer substrate. When scanning was completed, the substrate with the patterned structures was immersed in a development solution of propylene glycol monomethyl ether acetate (obtained from Sigma-Aldrich) to remove unpolymerized photoresist. The masterform was then nickel or nickel alloy electroformed to create the metal tool that was used for replication. The nickel plated tool was used to make impression molded samples with polypropylene resin (C700-35 resin, Dow Chemical, Midland, MI). The platens of a Carver press (Carver, Wabash, IN) were heated to 170° C. and the tool and resin were pressed together for 7 minutes at 1000 force pounds (˜4450 Newtons), followed by cooling under pressure until the temperature of the platens reached 80° C. The pressure was released and the molded microstructured substrate was removed from the tool.

The molded microstructured substrate had an upper surface and lower surface with overall dimensions of 25.4 mm (width), 76.2 mm (length), 1 mm (depth). The microstructures of the substrate were an array of linear prism microstructures positioned along the floor of a flow channel (3 mm width, 60 mm length) that was recessed below the upper surface of the substrate and had first and second open ends. The linear array of peak structures and adjacent valleys was oriented at an angle of 0 degrees with respect to the liquid flow direction of the finished device. The features of the linear prism microstructures are reported in Table 5. The prism features protruded above the floor of the flow channel. The wall surrounding the perimeter of the flow channel extended 100 micrometers above the tips of the prism structures to the upper surface. The first open end of the flow channel was fluidically attached to a semi-circular first cavity having a depth of 100 micrometers from the upper surface and a volume of 2.88 microliters. The first cavity formed the first aperture of the device. The first aperture served as the liquid sample intake reservoir of the final device. The opposite, second open end of the flow channel was fluidically attached to a rectangular shaped second cavity (5 mm width, 6 mm length, 250 micrometer depth from the upper surface). The second cavity formed the second aperture of the device. The second aperture served as the receiving reservoir for liquid sample exiting the flow channel.

The cover component of the device was a section of 3M Microfluidic Diagnostic Film 9975R (obtained from the 3M Company). The cover was positioned over the flow channel and the liquid sample intake reservoir sections and was adhesively attached to the surface of the microstructured substrate that surrounded the sample intake reservoir and flow channel sections. Prior to application, a circular hole (5 mm diameter) was laser cut into the cover component and oriented so that the center of the hole was positioned over the center of the sample intake reservoir on attachment of the cover to the microstructured substrate. The receiving reservoir was not covered.

TABLE 5

| | | | Apex | |
|---|---|---|---|---|
| Microstructured | Peak Height | Pitch | Angle | Apex |
| Surface | (micrometers) | (micrometers) | (degrees) | Shape |
| Example 8 | 200 | 107.7 | 30 | Sharp |

### Example 9

Devices were prepared according to the same procedure described in Example 8 with the following exceptions: the linear array of peak structures and adjacent valleys was oriented at an angle of 45 degrees with respect to the liquid flow direction of the finished device (orientation shown in FIG. 5D); the dimensions of the flow channel were 3 mm width, 40 mm length; the first aperture cavity had a depth of 300 micrometers and a volume of 8.7 microliters; and the second aperture cavity had dimensions of 5 mm (width), 6 mm (length), 300 micrometers (depth).

### Example 10

Devices were prepared according to the same procedure described in Example 9 with the exception that the linear array of peak structures and adjacent valleys was oriented at an angle of 90 degrees (i.e., perpendicular) with respect to the liquid flow direction of the finished device (orientation shown in FIG. 5C).

### Example 11

Devices were prepared according to the same procedure described in Example 8 with the exception that array of linear prism microstructures was replaced with an array of fluidically connected wells having circular shapes connected to adjacent wells by vents (shown in FIGS. 10A-B). Each well had a diameter of 200 micrometers, depth of 150 micrometers, and draft angle of 5 degrees. The vents had a length of 29 micrometers, width of 40 micrometers, a depth of 150 micrometers, and draft angle of 5 degrees. The wells located in the center of the flow channel were each connected to four other wells with each connection being via a vent and the spacing of vents being as shown in FIG. 10B. The wall surrounding the perimeter of the flow channel extended 100 micrometers above the top surfaces of the wells. The dimensions of the flow channel were 3 mm width, 40 mm length.

The first open end of the flow channel was fluidically attached to a semi-circular first cavity having a depth of 100 micrometers from the upper surface and a volume of 2.88 microliters. The first cavity formed the first aperture of the device. The opposite, second open end of the flow channel was fluidically attached to a rectangular shaped second cavity (5 mm width, 6 mm length, 250 micrometer depth from the upper surface). The second cavity formed the second aperture of the device.

### Example 12. Method of Separating Red Blood Cells from Blood

Human blood was collected in BD VACUTAINER citrate tubes (Becton, Dickinson and Company, Franklin Lakes, NJ) and used as citrated whole blood or citrated whole blood diluted 1:1 with 1× phosphate buffered saline (PBS).

The microstructured substrates described in Examples 8-11 were prepared and a cover component modified with tubing for blood instillation was attached to each substrate. The modified cover component was a section of 3M Microfluidic Diagnostic Film 9975R (obtained from the 3M Company) with a circular hole (5 mm diameter) laser cut into the cover component. Plastic tubing (0.05 inch ID, 0.09 inch OD) was inserted into the hole and secured with epoxy adhesive (3M SCOTCH-WELD Epoxy Adhesive DP100 Plus Clear, obtained from the 3M Company). Any tubing that extended beyond the adhesive surface of the cover component was removed with a razor blade. The cover was positioned over the flow channel and the liquid sample intake reservoir sections of the microstructured substrate and adhesively attached to the surface of the microstructured substrate that surrounded the two sections. The cover component was oriented so that the center of the hole was positioned over the center of the sample intake reservoir on attachment of the cover. The receiving reservoir was not covered. The tubing extended about 3 cm in length from the outer surface of the cover.

Each resulting device was placed on a horizontal surface (oriented so that the lower surface of the device faced the horizontal surface). A sample of blood (20-50 microliters) was added through the tubing to the sample inlet reservoir using a micropipette. The blood sample was allowed to wick to the end of the device by capillary flow or was advanced using positive pressure from the micropipette. A sufficient volume of blood was added to the device to fill the open volume of the flow channel without having excess blood in the intake reservoir. Any excess blood in the receiving reservoir was promptly removed from the reservoir using a micropipette or a KIMWIPE wiper (Kimberly-Clark Corporation, Irving, TX). Following administration of the blood sample, each device was maintained undisturbed on the horizontal surface for 5 minutes.

A 1 mL Luer-Lok syringe filled with mineral oil was attached to a section of plastic tubing and the mineral oil was partially dispensed into the tubing to leave a small air gap (about 10 cm of tubing length) at the open end of the tubing. The syringe was placed in a syringe pump (model NE-1600, New Era Pump Systems Inc). The open end of the tubing of the syringe assembly was connected to the open end of the tubing that extended from the device. The pump was activated with the flow rate set to 50 microliters/minute to force the blood sample from the flow channel with the volume of entrapped air. The blood sample that flowed out of the flow channel was collected as several 2-4 microliter aliquots. Each sample was collected as soon as an aliquot volume accumulated in the receiving reservoir.

For each collected sample, dilution samples of 1/10, 1/20, 1/100, and 1/200 in 1×PBS were prepared. A 2 microliter aliquot of each dilution sample was loaded onto an Agilent Take3 microvolume plate (TAKE3-SN, Agilent Technologies, Santa Clara, CA) with a micropipette. The plate included at least 1 well as a 1×PBS blank that was used for the dilutions per the manufacturer instructions. For each sample and for the 1×PBS blank, absorbance measurements were recorded at 406 nm, 414 nm, and 576 nm using an Agilent Synergy Neo2 plate reader (Agilent Technologies). The procedure in the section “Method for Determining Intact Red Blood Cell Content of Samples” (described below) was used to calculate the percent reduction of red blood cells from the blood samples submitted to each device using the procedure described in this example.

The results using citrated human whole blood are provided in Table 6 and the results using citrated human whole blood diluted 1:1 in 1×PBS are presented in Table 7. Devices of Comparative Example B (i.e., devices without a microstructured surface) were also tested. For each type of device, the results reported in Tables 6 and 7 are from technical replicates of three devices (n=3). The calculated percent reduction in red blood cells for each replicate device was averaged from the entire volume of aliquot samples collected from the device.

TABLE 6

| Device Prepared with | Percent RBC | Standard |
|---|---|---|
| Microstructured Substrate from | Reduction | Deviation |
| Example 8 | 16.5% | 6.5% |
| Example 9 | 5.2% | 4.3% |
| Example 10 | 25.5% | 3.9% |
| Example 11 | 14.1% | 10.5% |
| Comparative Example B | −1.2% | 6.7% |

TABLE 7

| Device Prepared with | Percent RBC | Standard |
|---|---|---|
| Microstructured Substrate from | Reduction | Deviation |
| Example 8 | 42.1% | 0.3% |
| Example 9 | 8.4% | 16.5% |
| Example 10 | 10.6% | 23.9% |
| Example 11 | 35.0% | 9.7% |
| Comparative Example B | 4.7% | 10.9% |

### Method for Determining Intact Red Blood Cell Content of Samples

In order to simultaneously measure intact red blood cell content and lysed red blood cell content of samples, a calibration curve of a dilution series was prepared with known inputs of lysed and intact human red blood cells. Citrated human whole blood was used as the sample of 100% intact red blood cells. To create a 0% intact red blood cell sample, an aliquot of whole blood was lysed by vortexing for 1 minute using a ZR BashingBead lysis tube (product no. S6012-50, Zymo Research, Irvine, CA). The tube was centrifuged at 10,000×g for 1 minute and the supernatant, containing only lysed cell content, was transferred to a fresh 1.5 mL Eppendorf tube. Standard samples of intact-to-lysed red blood cells for a dilution series were prepared by mixing varying ratios of known intact and lysed cells that ranged from 100% to 0% intact red blood cells. The intact red blood cell concentrations of the standard samples were confirmed using a C-CHIP Disposable Hemacytometer according to the manufacturer's instructions.

Each standard sample was diluted in 1×PBS (so that the absorbances would be in the dynamic range of the plate reader) and analyzed in technical triplicate using an Agilent Synergy Neo2 plate reader with the Take 3 multivolume plate (sample volumes and blanks were selected per manufacturer instructions). Absorbances at 406 nm, 414 nm, and 576 nm were measured for each standard sample).

The ratio of A_{414 nm}/A_{576 nm} was plotted versus the known input of % intact red blood cells. A_{414 nm}=the sample absorbance at 414 nm and A_{576 nm}=the sample absorbance at 576 nm. The subtraction of the blank (1×PBS) was used for background subtraction. The dataset was fitted with a logarithmic curve to generate Equation A. Equation A was used to calculate the percentage of intact red blood cells from a suspension containing blood.

$$\% intact = - 49.6 ln ( \frac{{A}_{414 n m} - {A}_{P BS , 414 n m}}{{A}_{576 n m} - {A}_{P BS , 576 n m}} ) + 100 \qquad Equation A$$

In Equation A, “% intact”=the percentage of the red blood cells in the suspension that were intact, “A_{414 nm}”=the absorbance of the 414 nm wavelength of the blood sample, “A_{PBS,414 nm}”=the absorbance of the 414 nm wavelength of 1×PBS, “A_{576 nm}”=the absorbance of the 576 nm wavelength of the blood sample, and “A_{PBS,576 nm}”=the absorbance of the 576 nm wavelength of 1×PBS.

The absorbance signal at 406 nm of each sample was adjusted by the ratio of percent cells to calculate the signal from intact red blood cells with Equation B.

$${Ai}_{406 n m} = \frac{\% intact}{100 \%} \times ( {A}_{406 n m} - {A}_{PBS , 406 n m} ) \qquad Equation B$$

In Equation B, “Ai_{406 cm}”=the absorbance of the 406 nm wavelength of the blood sample attributed to intact red blood cells, “% intact”=the percentage of the red blood cells in suspension that are intact as calculated by Equation A, “A_{406 cm}”=the absorbance of the 406 nm wavelength of the sample, and “A_{PBS,406 nm}”=the absorbance of the 406 nm wavelength of 1×PBS.

After the absorbance of the 406 nm wavelength was adjusted for intact and lysed cells in Equation B, the absorbance signal of a blood sample added to a device was compared to the absorbance signal of the corresponding blood aliquots collected from the device according to Equation C in order to calculate the percent red blood cell (RBC) reduction.

$$Percent red blood cell reduction = \frac{A {i}_{406 n m , i n p u t} - A {i}_{406 n m , o u t p u t}}{A {i}_{406 n m , output}} \times 100 \qquad Equation C$$

In Equation C, “Ai_{406 nm, input}”=the absorbance of the 406 nm wavelength of the blood sample added to the device attributed to intact red blood cells, as calculated by Equation B and “Ai_{406 nm, output}”=the absorbance of the 406 nm wavelength of the blood sample collected from the device attributed to intact red blood cells, as calculated by Equation B.

### Preparatory Example 6. Microstructured Film with Upstanding Stems

A polypropylene (PP) microstructured film of FIG. 11 having discrete stem structures with angled sidewalls was prepared by the molding process according to Example 1 of U.S. Pat. No. 9,358,714 (Chandrasekaran), except that no beta nucleating master batch was included, and then the film was corona treated using a BD-20AC Laboratory Corona Treater (Electro-Technic Products, Chicago, IL). 3-Dimensional micrographs of the microstructured film were taken using a Keyence VK-X3100 3D Surface Profilometer (Keyence Corporation, Itasca, IL) and measurements were taken using the accompanying VK-X 3000 MultiFileAnalyzer software package. The microstructured film had a total thickness of about 345 micrometers with a staggered array of 2000 stem features per square inch. The stem features had generally flat surfaces at the apex (i.e., truncated cone shape). The thickness of the backing layer was 83.5 micrometers. In Tables 8 and 9, the dimensions for stem height, diameter of the stems at the base in the down web direction, diameter of the stems at the base in the cross web direction, diameter of the stems at the apex in the down web direction, diameter of the stems at the apex in the cross web direction, center-to-center distance (pitch) between stems in the down web direction, and center-to-center distance (pitch) between stems in the cross web direction are reported.

TABLE 8
Stem Feature Dimensions of Preparatory
Example 6 Microstructured Film

| | Center-to-Center Distance | Center-to-Center Distance |
|---|---|---|
| | Between Stems in Down | Between Stems in Cross |
| Stem Height | Web Direction | Web Direction |
| (micrometers) | (micrometers) | (micrometers) |
| 261.5 | 993.4 | 557.6 |
| (SD = 3.7) | (SD = 21.0) | (SD = 13.0) |

TABLE 9
Stem Feature Dimensions of Preparatory
Example 6 Microstructured Film

| | |
|---|---|
| Diameter of Stems at Apex | Diameter of Stems at Base |
| (micrometers) | (micrometers) |

| Down Web | Cross Web | Down Web | Cross Web |
|---|---|---|---|
| Direction | Direction | Direction | Direction |
| 146.6 | 127.8 | 235.9 | 185.7 |
| (SD = 9.2) | (SD = 1.8) | (SD = 2.9) | (SD = 2.8) |

### Example 13. Preparation of Device Containing Microstructured Film with Upstanding Stems

The procedure described in Example 1 was followed with the following modifications. First, the microstructured film of Preparatory Example 1 was replaced with the microstructured film of Preparatory Example 6 as the third film component of the device. Second, epoxy was used to seal the two long edges of the device and the narrow edge proximal to the first aperture. The narrow edge that formed the second aperture was not sealed.

### Example 14. Preparation of Device Containing Microstructured Film with Upstanding Stems and Flocculant Coating of the Microstructured Array

A flocculant solution of polyethyleneimine (PEI) (branched, MW of 70,000 Da, 30% weight/volume aqueous solution, catalog number 00618, obtained from Polysciences, Inc., Warrington, PA) was further diluted in two steps with 1:10 (weight:volume) deionized water followed by 1:10 volume:volume with deionized water. The diluted flocculant solution (30-100 microliters) was added by pipette to the rectangular opening 880 of a device of Example 13. The applied PEI flocculant solution was allowed to air dry overnight at ambient conditions to provide a flocculant coated microstructured array.

### Example 15. Preparation of Device Containing Microstructured Film with Upstanding Stems and Flocculant Coating of the Microstructured Array

An aqueous flocculant solution of guanylated polyethyleneimine (G-PEI) was prepared as described in Example 1 of U.S. Pat. No. 10,087,405 (Swanson et al.) without the addition of butanedioldiglycidylether. The flocculant solution (30-100 microliters) was added by pipette to the rectangular opening 880 of a device of Example 13. The applied G-PEI flocculant solution was allowed to air dry overnight at ambient conditions to provide a flocculant coated microstructured array.

### Example 16. Method of Separating Red Blood Cells from Blood

Whole human blood collected in EDTA tubes was obtained from the Oklahoma Blood Institute, Oklahoma City, OK. The initial hematocrit of the human blood sample was measured using a Zip-IQ PCV Centrifuge (LW Scientific Incorporated, Lawrenceville, GA).

In the method, the module with syringe pump for delivering blood samples described in Example 7 was used. A device selected from Examples 13-15 was placed on a horizontal surface. A sample of the whole human blood (50-100 microliters) was added to the first aperture 850 of the device. The blood was allowed to wick to the end of the device by capillary flow and the device was maintained undisturbed for 10 minutes to allow the red blood cells to settle in the microstructured array section. Next, the pump was activated with the flow set to 100 microliters/minute. The blood sample flowing out of the device from the second aperture 860 was collected as a series of 5 microliter aliquots.

A standard calibration curve was prepared from a dilution series of whole blood in water to correlate RBC count with absorbance at 406 nm. Each blood sample tested was diluted in water (to lyse cells and so that the absorbance was in the dynamic range of the plate reader) and analyzed in technical duplicate using an Agilent Synergy Neo2 plate reader with the Take 3 multivolume plate (sample volumes and blanks were selected per manufacturer instructions). Deionized water with a resistivity greater than 18 megaohm-cm prepared from a SYNERGY UV Water Purification System (MilliporeSigma, Burlington, MA) was used to prepare all dilutions. Absorbance at 406 nm was measured for each sample. The percent red blood cell (RBC) reduction of a blood sample was calculated by comparing the absorbance of an aliquot of blood collected from the device to the absorbance of the whole blood sample added to the device according to Equation D.

$$Perecent RBC reduction = ( 1 - \frac{{Absorbance}_{406 n m , output}}{{Absorbance}_{406 n m , input}} ) \times 100 \qquad Equation D$$

In Equation D, “Absorbance_{406 nm,output}”=the absorbance of the 406 nm wavelength of the blood sample collected from the device. “Absorbance_{406 cm,input}”=the absorbance of the 406 nm wavelength of the blood sample added to the device. For each type of device, the results are reported in Table 10. A single device of each type was tested. The calculated percent reduction in red blood cells was averaged from all of the aliquot samples collected from a device. About 10 aliquot samples were collected from each device.

TABLE 10

| Device | Percent RBC Reduction |
|---|---|
| Example 13 | 20.9% |
| Example 14 | 84.4% |
| Example 15 | 79.6% |

### Example 17. Method of Separating Red Blood Cells from Blood

The method of Example 16 was followed using a single device of Example 13 (n=1) and a blood sample that included PEI flocculant. For the blood sample, a flocculant solution of polyethyleneimine (PEI) (branched, MW of 70,000 Da, 30% weight/volume aqueous solution, catalog number 00618, obtained from Polysciences, Inc.) was prepared by making a 1/10 dilution in PBS (e.g., 1 mL flocculant+9 mL 1×PBS). A 90 microliter aliquot of whole human blood was mixed with 10 microliters of the flocculant solution in a tube. The resulting blood sample was mixed (3-5 times) using a pipette and then incubated for 10 minutes at room temperature. The incubated blood sample was pipette mixed (3-5 times) and then about 100 microliters of the sample was added to the first aperture of the device. A total of seven aliquots were collected from the device. The calculated percent RBC reduction was 64.4%. The calculated percent reduction in red blood cells was averaged from all of the aliquot samples collected from the device.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. A method of separating red blood cells from blood, the method comprising:
obtaining a device comprising:
a microstructured substrate comprising a plurality of microstructures extending across a first surface of the microstructured substrate, wherein at least a portion of an exterior surface of the plurality of microstructures are configured to allow capillary action;
a cover disposed a selected distance apart from a top of the first surface of the microstructured substrate;
at least one sidewall that attaches the cover to the first surface of the microstructured substrate along a perimeter of the first surface of the microstructured substrate;
a first aperture defined by at least one of the microstructured substrate or the cover; and
a second aperture defined by at least one of the microstructured substrate or the cover;
wherein the first surface of the microstructured substrate together with the at least one sidewall defines a first open volume that is a total of open space located between the plurality of microstructures from a bottom to a top of each microstructure, wherein the cover together with the top of the first surface of the microstructured substrate and at least one sidewall defines a second open volume located adjacent to the first open volume, and taking a total of the combined first open volume and second open volume to be 100% open volume, the first open volume has a larger percent of the 100% open volume than a volume percent of red blood cells that is present in the blood;
filling the device with a volume of blood through the first aperture via capillary action;
waiting for a time sufficient for at least a portion of the red blood cells to settle within the first open volume of the plurality of microstructures; and
applying pressure to the device, thereby causing at least 10% of the initial volume of blood, from which at least some of the red blood cells have been retained within the first open volume of the plurality of microstructures, to flow out of the device through either the first aperture or the second aperture.

2. The method of claim 1, wherein the at least one sidewall is a portion of the microstructured substrate.

3. The method of claim 1, wherein at least 15% of the blood is caused to flow out of the device upon the application of pressure.

4. The method of claim 1, wherein the time is sufficient for at least 20% of the red blood cells to settle within the first open volume of the plurality of microstructures.

5. The method of any of claim 1, wherein the microstructured substrate is a microstructured film.

6. The method of claim 1, wherein at least a portion of the exterior surface of the plurality of microstructures comprises a substance selected from the group consisting of a surfactant, a surface treatment, a hydrophilic polymer, a flocculant, and any combination thereof.

7. The method of claim 6, wherein the flocculant is hydrophilic and non-hemolytic.

8. The method of claim 6, wherein the flocculant comprises a modified or unmodified aminopolymer selected from the group consisting of polyethylenimine, polylysine, polyaminoamides, polyallylamine, polyvinylamine, polydimethylamine-epichlorohydrin-ethylenediamine, polydiallyldimethylammonium chloride, cationic polyacrylamide (CPAM), polyaminosiloxanes, and dendrimers formed from polyamindoamine (PAMAM) and polypropylenimine.

9. The method of claim 6, wherein the flocculant comprises a modified or unmodified polyethylenimine polymer.

10. The method of claim 6, wherein at least a portion of the flocculant dissolves into the blood following the filling of the device with the volume of blood.

11. The method of claim 10, wherein the flocculant is present in the volume of blood in an amount of 0.01 to 5000 micrograms per milliliter of blood.

12. The method of claim 1, wherein the pressure is positive pressure.

13. The method of claim 1, wherein the pressure is negative pressure.

14. The method of claim 1, wherein the first aperture is defined by the cover.

15. The method of claim 1, wherein the second aperture is defined by the microstructured substrate and the cover.

16. The method of claim 1, wherein the blood is undiluted.

17. The method of claim 1, wherein the red blood cells settle solely due to gravity.

18. The method of claim 1, wherein the device further comprises an adhesive layer disposed between the cover and the microstructured substrate.

19. The method of any of claim 1, wherein the microstructures comprise a plurality of ribs alternated with channels extending across the first surface of the microstructured substrate, and wherein each of the ribs comprises side walls and a top surface and each of the channels comprises a bottom surface.

20. The method of claim 19, wherein the top surface of each rib is the top of a cap disposed on the side walls and the cap has a width greater than a width between opposing side walls.

21. The method of claim 1, wherein the microstructures comprise an array of peak structures and adjacent valleys, wherein the valleys have a maximum width ranging from 10 microns to 500 microns and the peak structures have an apex angle of greater than 5 degrees and up to 90 degrees.

22. The method of claim 21, wherein the array of peak structures and adjacent valleys extending across a first surface of the microstructured substrate is oriented at an angle between 0 and 90 degrees with respect to a flow direction of the device

23. The method of claim 11, wherein the array of peak structures and adjacent valleys further comprises gaps in between adjacent peak structures.

24. The method of claim 1, wherein the microstructures comprise a two-dimensional (x- & y-axes) array of projections arranged across the first surface of the microstructured substrate; wherein each of the projections comprises a base, a top, and one or more sides connecting the top to the base.

25. The method of claim 1, wherein the microstructured substrate comprises a microstructured layer with first and second major surfaces, wherein the microstructures comprise a plurality of cavities extending between the first and second major surfaces; wherein each cavity comprises a first opening, a second opening and at least one side wall extending between the first opening and the second opening.

26. The method of claim 1, wherein the microstructures comprise a facet and a side wall meeting the facet at a ridge of the microstructure and wherein the facet and the side wall define an oblique angle therebetween.

27. The method of claim 1, wherein the microstructures comprise an array of fluidically connected wells, wherein at least some of the wells are fluidically connected to at least two adjacent wells, each connected via a vent.

28. The method of claim 1, wherein the microstructures comprise an array of upstanding stems extending across the first surface of the microstructured substrate.

29. The method of claim 1, wherein the volume of the blood filled through the first aperture is up to 100 microliters of the blood.

30. The method of claim 1, wherein a ratio of the first open volume to the second open volume is greater than 1:1.

31. The method of claim 1, further comprising passing the blood through a filter before entering the device, passing the blood from which at least some of the red blood cells were retained within the first open volume of the plurality of microstructures after exiting the device, or both.

32. The method of claim 1, further comprising adding a flocculant to the volume of blood before filling the device with the volume of blood.

33. The method of claim 32, wherein the flocculant is added and is present in an amount of 0.01 to 5000 micrograms/mL of blood.

34.-35. (canceled)
